(19) United States
(12) Patent Application Publication
(10) Pub. No.: US 2010/0217979 A1
(43) Pub. Date: Aug. 26, 2010

(54) System and Method for Providing Certified Proof of Delivery Receipts for Electronic Mail

(76) Inventor: Karim Yaghmour, Sherbrooke (CA)

Correspondence Address: JACOBSON HOLMAN PLLC, 400 SEVENTH STREET N.W., SUITE 600, WASHINGTON, DC, 20004, US

(21) Appl. No.: 12/086,702

(22) PCT Filed: Dec. 19, 2006
(86) PCT No.: PCT/CA2006/002082

§ 371 Date: Apr. 30, 2010

(30) Foreign Application Priority Data
Dec. 19, 2005 (CA) 2,531,163
Dec. 20, 2005 (CA) 2,530,937

(51) Int. Cl. G06F 15/16; H04L 9/00; H04L 9/32

(52) U.S. Cl. 713/168; 709/206; 380/44

(57) ABSTRACT

The present disclosure provides a system and method for certifying the delivery of electronic mail messages. In one embodiment, the sender contacts a proof-of-delivery-request creation server which receives the message the sender would like to obtain a proof-of-delivery for, generates a processed message and a proof-of-delivery-request, and returns both to the sender. The sender then uses his regular email infrastructure to transmit to the recipient the processed message and the proof-of-delivery-request as a single email. Upon receiving the sender's email, the recipient contacts a proof-of-delivery-request processing server operated by a trusted-third-party and sends it the proof-of-delivery-request. Said server processes the proof-of-delivery-request, notifies the sender that the recipient has received the message and provides the recipient with information usable for extracting the original message from the processed message.

This application is related to Canada Application No. 2,531,163, titled “System and Method for Providing Certified Proof of Delivery Receipts for Electronic Mail,” filed on Dec. 19, 2005, the entire contents of which are incorporated herein by reference; and Canada Application No. 2,530,937, titled “System and Method for End-to-End Electronic Mail Encryption,” filed on Dec. 20 2005, the entire contents of which are incorporated herein by reference.

### FIELD OF INVENTION

The present disclosure relates to data processing and, more particularly, to a method and system for certifying the delivery of electronic mail messages using mechanisms based on encryption.

### BACKGROUND

Electronic mail (email) has become a primary means of communication for a large number of organizations, businesses and individuals. Its simplicity, efficiency, and, most importantly, its virtually inexistent cost have made it very popular. In recent times, however, many problems have come to plague the use of email. The ever-increasing quantity of spam and phishing circulating on networks, for example, have put a dent in email's reliability. Even the solutions used to alleviate such problems, like mail filters, have only exacerbated the problem further by making it more difficult to guarantee the delivery of a sender's email. The issues are such that users are increasingly relying on more traditional means for verifying the delivery of their emails. Many users, for example, will not hesitate to phone a recipient to make sure they received a piece of email. Currently, there are a few methods allowing the sender to positively ensure that a recipient has indeed received a sent email, some of which are covered in the following.

Some mail client software (i.e. the software users use to read, write, send, and receive email) allows the sender to flag some email as requiring a receipt. In that case, the recipient is prompted by his mail client whether he wants to send a receipt back to the sender. This, however, is a voluntary process and the recipient may decide not to send such a receipt and still read the email. In the case where the recipient does not accept to send the receipt, the sender is unable to determine whether the recipient has indeed received the email and would need to use other means of communication in order to verify that the recipient has indeed received the email. Furthermore, this feature is not supported by all mail client software. In other words, while the sender may indeed select to request a delivery receipt from the recipient, the recipient's email software may not even prompt him to send one.

Intermediary Storage Gateway

While there are many variations and different products and services implementing this method, it typically involves the sender sending his emails to the recipient through a special server or provider, the latter storing the email and sending a notification to the end recipient, usually in the form of another email, that an email is stored for him by the underlying system and providing instructions as to how to retrieve the email. Upon retrieving the sender's email, the recipient thereby triggers a receipt to be sent back to the sender. This functionality is often combined with a mechanism for allowing senders to transmit secure content to recipients thereby allowing senders to transmit secure content to recipients and obtain receipts when such content is delivered.

While this method is indeed effective in making sure that the recipient cannot read the message without triggering a receipt being sent to the sender, it has a number of major drawbacks. First, it is counter-intuitive for the recipient and possibly even for the sender. Indeed, it typically requires the sender and recipient to use a web interface instead of the typical email client application which they usually use. Even when the problem is alleviated for the sender by way of providing them with a plugin to their email client application, the recipient must still be directed to a website to retrieve their email, which requires the recipient to use a different interface than the one he typically uses to read and send email. Second, the use of this type of solution often requires that the sender change his infrastructure to use a server or provider implementing this system instead of his standard email server or provider. In an ever-more complex networking environment, this may pose significant problems to the IT team especially if the failure of the added components would lead to email outages. Third, the fact that the sender must entrust his email to a third party constitutes a potential security risk. There is, in fact, nothing precluding the third party, or one of their employees, from accessing the content. Also, if such a solution was widely adopted, there is nothing precluding attackers from concentrating their efforts into attempting to breach the provider's servers in order to access sensitive material. Fourth, because the recipient is redirected to a website using an email notification, there is nothing precluding malicious third parties from sending similarly-formatted email claiming to be the sender in order to lure recipients in providing sensitive private information—a technique commonly known as “phishing”. Fifth, the fact that the sender's infrastructure needs to be changed likely means that the addition of this new functionality requires interrupting email service while the said functionality is deployed.

Embedded Web Image

In this method, a provider embeds a URL in a sender's HTML-written email, records all accesses to this URL, and reports those accesses back to the sender. Basically, this method takes advantage of the fact that most modern email clients are capable of reading HTML emails and, therefore, are typically configured to automatically download images which are pointed to by incoming HTML emails. This automatic download triggers a mechanism that records the time at which the access was made and how long the image was displayed. While this technique is used by apparent legitimate services, it is also widely used by spammers and phishing attempts to record user behavior. It is often considered spyware and its use by senders is regarded by some as immoral because the recipient is spied on unknowingly. In addition, this technique will not work with email clients configured to read email as text, neither will it work when the recipient's email client is configured not to load remote images pointed to by HTML emails.

Transactional Email Gateways

In U.S. Publication No. 2005/0251861 and U.S. Publication No. 2005/0210106 a system and method are described wherein the outgoing mail server gateway marks outgoing emails with a key, forwards the email to the recipient, receives requests for validating the key from the end recipients, validates the key, and responds to the recipient with a validation status and, by the same token, flags the email as having been properly delivered.

There are a number of drawbacks to this approach. First and foremost, nothing precludes the recipient not to request the validation request, and therefore the recipient from reading the email without acknowledging receipt. The underlying premise of this system and method is that the recipient has a vested interest in verifying the email's origin for purposes of email authentication in order to avoid receiving spam. This need, however, does not preclude recipients from selectively forsaking such verification in order to avoid providing the sender with a delivery receipt. Second, this method involves modifying a network's topology and/or the behavior of existing mail servers on the sender's network. As discussed earlier, this approach is impractical in modern network setups because of the likely necessity to interrupt email functionality during installation and the potential for email outage in case the system and method fail to operate properly.

Trusted Third-Party (TTP) Encryption Key Storage

In U.S. Pat. No. 6,807,277 and U.S. Publication No. 2003/0147536 a method and system are described wherein a sender relies on a TTP's key server to obtain a key, uses the key to encrypt a message to a recipient, sends the encrypted message and key retrieval information to the recipient. Upon receipt, the recipient uses the key retrieval information to request the key from the TTP which retrieves said key from storage, sends it to the recipient and notifies the sender that the recipient has, in effect, “received” the message. The recipient can then use the key to decrypt and view the message. Provisions are also provided for sending key parts to the key server and other key parts to recipients and requiring recipients to retrieve the missing key parts from the TTP, thereby triggering proof-of-delivery.

While it marks an improvement over approaches that require that the sender's email be stored on TTP's servers for the recipient to retrieve it, this approach suffers from a number of shortcomings. First, the TTP is required to store data for each message sent by the sender, which posses significant scalability issues on the TTP. Indeed, because it must store a key for each outgoing email, its load and storage requirements increase as a function of the number of outgoing emails processed according to this system and method. Second, both the sender and the recipient are required to share the same exact TTP. This, too, is a scalability issue since it imposes that the sender must determine beforehand the TTP that will be used by the recipient. In addition, this limitation is also an availability issue since by sharing the same TTP, the recipient would likely be unable to process his email if the designated TTP became unavailable, even if there were other TTPs offering similar functionality that were still available.

TTP Message Decryption

In their article “TRICERT: A Distributed Certified E-Mail Scheme” presented at the 2001 “Network and Distributed System Security Symposium” in San Diego, Calif., Ateniese et al. describe a method wherein the sender encrypts the message using the recipient's public key, encrypts the result using the TTP's public key, signs the result with his private key and sends this last result to the recipient. Upon receiving the message, the recipient first validates the sender's signature, then creates and signs a receipt which he sends along with the sender's message to the TTP. The TTP verifies the recipient's signature, and, if it is valid, notifies the sender that the message was indeed delivered, decrypts the encrypted message using its private key and sends the result back to the recipient. The recipient can then decrypt the message using his private key and read it

Like the previously-discussed approaches, there are a number of limitations to this approach. First, there is a shortcoming in the fact that there is a requirement for the recipient to transmit the entirety of the received message to the TTP and the TTP doing the same back again once having decrypted the message. This results in the sender imposing on the recipient added network traffic that the recipient, or his employer or IT staff, may not which to avoid. Second, this mechanism assumes the recipient possesses a private/public key pair. In other words, the recipient must also be known or identifiable to the TTP before senders can send him messages that trigger proof of delivery. As has been demonstrated by the public record on the use of PKI, few email users, relative to all email users, have gone through the trouble of understanding PKI, publishing their public keys, and making their public keys known to TTPs such as Certificate Authorities (CAs) and the likes. This mechanism cannot therefore realistically be used by senders intending to communicate with many different recipients, most of which will not possess key pairs or be known to the TTP used by the sender.

TTP Session Key Storage

In U.S. Pat. No. 6,904,521, a method and system are described wherein the sender provides a TTP (therein referred to as an “arbiter”) with a transaction identifier and a matching encrypted session key for storage by the TTP, encrypts the transaction identifier using a recipient's public key and sends the encrypted transaction identifier to the recipient. The recipient, thereafter, decrypts the transaction identifier using his private key, retrieves the encrypted session key from the TTP using the decrypted transaction identifier, thereby triggering a proof-of-delivery, and obtaining the encrypted session key which is thereafter itself decrypted and used to decrypt the received email.

This approach is very similar to the TTP encryption key storage approach discussed earlier and suffers from many of the same drawbacks. Namely, the TTP must store data for each email sent using this technique, which creates scalability issues, and the approach assumes that the sender and recipient share the same TTP, which also creates scalability issues in addition to having inherent reliability issues. In addition to these limitations, this approach also requires that the recipient have published a public key beforehand for encrypting the session key prior to its delivery to the TTP by the sender. As explained earlier, the requirement for recipients to possess a cryptographic identity greatly limits the applicability of a proof-of-delivery mechanism.

TTP Symmetric Key Decryption

In U.S. Publication No. 2002/0143710 a method and system are described wherein the sender encrypts a message using a symmetric key, encrypts the symmetric key using the TTP's public key and sends both the encrypted message and the encrypted symmetric key to the recipient. Provisions are also provided for sending the encrypted symmetric key to the TTP instead of sending it to the recipient, but the focus is on the scheme where the key is sent to the recipient along with the encrypted message. Upon receiving the encrypted message and the encrypted symmetric key, the recipient produces a receipt and signs it with his own private key. He then submits the encrypted symmetric key along with the signed receipt to the TTP. The TTP first verifies the signed receipt and, if it is valid, forwards the receipt to the sender, thereby notifying him that the message has been “received”, decrypts the symmetric key using its private key and provides the decrypted symmetric key to the recipient. The recipient can then use the symmetric key to decrypt the message it has received from the sender.

While this approach improves on previous approaches in that it doesn't require the TTP to store data for each email requiring a proof-of-delivery, it still suffers from a number of drawbacks. First and foremost, this approach suffers from the same major drawbacks as in the TTP message decryption approach, namely that the recipient is assumed to be known or identifiable to the TTP. A recipient that is not known to the TTP and does not himself possess a private/public key pair cannot therefore participate in exchanges where messages sent to him are meant to trigger proof of delivery. Second, the fact that the symmetric key is encrypted using the TTP's public key means that the sender, and therefore the organization he works for, cannot, in case of need—such as forensic analysis or data recovery/retrieval—, decrypt messages sent using this method. This is especially problematic as legislative and judicial processes are increasingly requiring organizations to provide trustworthy and readable records of all emails. Third, the fact that the sender himself is encrypting the message means that the sender's organization cannot itself audit the message's content prior to it being sent to the recipient, an increasingly important requirement for organizations for a number of reasons, including regulatory and compliance requirements. Fourth, as in previous methods, this approach assumes that the sender and recipient share the same TTP. This issue raises the same problems mentioned earlier for cases where both sender and recipient share the same TTP. Fifth, in this approach the same key pair, that of the TTP, are used for all transactions. There is a risk, therefore, that the entire functionality may be compromised should the TTP's private key be compromised. The article “Certified Email with a Light On-Line Trusted Third Party: Design and Implementation” by Abadi et al. presented at WWW2002 in Honolulu, Hi. describes a very similar technique which, consequently, suffers from many of the same drawbacks.

Current Needs

There are also other existing and proposed systems, including combinations of the above-described schemes. However, few have the ability to reliably provide certified proof of delivery receipts without modifying the sender's networking infrastructure, without requiring the sender to entrust his email to a third party, and without using dubious methods to spy on the recipient's behavior, while still requiring the recipient to confirm receipt upon reading a sender's email. Even those that achieve these goals using a TTP have not been designed to take in account how modern organizations deploy and maintain their networks and user configurations while catering for the needs created by the problems facing all email systems nowadays including spam, viruses and phishing. In addition, none have succeeded in gathering mainstream adoption nor established themselves as the preferred method for providing senders with certified delivery receipts for email.

There is thus a need for automatically and reliably informing a sender that an email has been properly received by a recipient. There is thus also a need for an email proof-of-delivery system and method wherein the recipient must accept to provide the proof-of-delivery in order to read the received email. Furthermore, there is thus also a need for an email proof-of-delivery system and method wherein the recipient receives, prior to having to provide the proof-of-delivery, the entirety of the email sent to him in a form that requires him to provide the proof-of-delivery in order to read the content of the email he received.

There is thus a need for an email proof-of-delivery system and method wherein the existing email infrastructure remains unchanged, in as much as possible, and would therefore not be impacted, or be impacted as little as possible, by the use of such a system and method by the existing users. Furthermore, there is thus also a need for an email proof-of-delivery system and method that intuitively integrate into users' existing habits.

### SUMMARY OF THE INVENTION

An object of the present disclosure is to provide an email proof-of-delivery system and method that overcome at least one of the previously listed drawbacks and that satisfy at least one of the above-mentioned needs.

Another object of the present disclosure is to provide an email proof-of-delivery system and method that enable a sender of reliably verifying that a recipient has indeed received a given email without requiring the sender to rely on additional means of communication, such as the telephone or fax, to make such verification.

Another object of the present disclosure is to provide an email proof-of-delivery system and method wherein the failure of the proof-of-delivery system and method would not result in an email outage. In other words, existing email infrastructure should be left unaffected by the failure of the functionality enabling or providing proof-of-delivery.

Another object of the present disclosure is to provide an email proof-of-delivery system and method wherein the sender need not entrust their email for storage by a TTP.

Another object of the present disclosure is to provide an email proof-of-delivery system and method which would be difficult for malicious third parties to abuse from in order to conduct spam or phishing attacks.

Another object of the present disclosure is to provide an email proof-of-delivery system and method wherein the recipient is a knowing participant in the proof-of-delivery process.

Another object of the present disclosure is to provide an email proof-of-delivery system and method wherein the initial deployment of the proof-of-delivery functionality imposes no, or few, perturbations on the existing email infrastructure.

Another object of the present disclosure is to provide an email proof-of-delivery system and method wherein the scalability of the components part of the system and method does not depend, or depends in as little as possible, on the number of emails processed by said system or method.

Another object of the present disclosure is to provide an email proof-of-delivery system and method wherein the network traffic necessary for the recipient to process his email for proof-of-delivery is minimized.

Another object of the present disclosure is to provide an email proof-of-delivery system and method wherein recipients designated by a sender in a sent email do not need to have previously published cryptographic identities, such as a public key, or otherwise be known to any TTP.

Another object of the present disclosure is to provide an email proof-of-delivery system and method wherein the sender and recipient need not share the same TTP. In other words, embodiments may be provided wherein the recipient may decide after having received the email requiring a proof-of-delivery which TTP to interact with in order to process the proof-of-delivery.

Another object of the present disclosure is to provide an email proof-of-delivery system and method relying on public key cryptography wherein the key pair being used varies according to the sender. In other words, the system and method are built to mitigate the risks associated with the compromising of any given private key.

Another object of the present disclosure is to provide an email proof-of-delivery system and method relying on private key cryptography wherein the key pairs used may be replaced from time to time. As in the previous object, the system and method are built to mitigate the risks associated with the compromising of any given private key.

At least one of the preceding objects is met, in whole or in part, by the present disclosure, in which there is provided a system and method for providing certified proof-of-delivery receipts for electronic mail.

According to the present disclosure, there is provided a system for generating a proof-of-delivery for an email, comprising:

an email transmission module configured for sending an email;

a proof-of-delivery-request creation module operating remotely from the email transmission module, the proof-of-delivery-request creation module being configured for producing a proof-of-delivery-request in response to a request for creating the proof-of-delivery-request;

a proof-of-delivery-request creation trigger module connectable to the proof-of-delivery-request creation module, the proof-of-delivery-request creation trigger module being configured for generating the request for creating the proof-of-delivery-request contemporaneously with the sending of the email;

a proof-of-delivery-request processing module configured for generating a proof-of-delivery for the email in response to a request for processing the proof-of-delivery-request;

an email reception module configured for receiving the email; and

a proof-of-delivery-request processing trigger module connectable to the proof-of-delivery-request processing module, the proof-of-delivery-request processing trigger module being configured for triggering the request for processing the proof-of-delivery-request contemporaneously with the reception of the proof-of-delivery-request, whereby the generation of the proof-of-delivery by the proof-of-delivery-request processing module is a necessary condition for a recipient to read the email received by the email reception module.

The system may further comprise a proof-of-delivery-request transmission module configured for causing the sending of the proof-of-delivery-request and a proof-of-delivery-request reception module configured for receiving the proof-of-delivery-request. Also, the system may also comprise a random key generation module connectable to the proof-of-delivery-request creation module, wherein the random key generation module being configured for generating a symmetric key. In addition, the system may further comprise a symmetric key encryption module connectable to the proof-of-delivery-request creation module, the symmetric key encryption module being configured for producing an encrypted symmetric key as a function of a public key and the symmetric key, wherein the encrypted symmetric key is made to be a component of the proof-of-delivery-request. The system may also further comprise an email encryption module connectable to the proof-of-delivery-request creation module, the email encryption module being configured for producing an encrypted email as a function of the symmetric key. Moreover, the system may further comprise a proof-of-delivery-request formatting module configured for producing an email formatted for proof-of-delivery by combining the encrypted email with the proof-of-delivery-request. In addition, the system may further comprise a proof-of-delivery-request transmission module configured for substituting the email with the email formatted for proof-of-delivery, wherein said substitution is effected contemporaneously with the transmission of the email by the email transmission module. The system may also further comprise a proof-of-delivery-request processing module configured for receiving the proof-of-delivery-request part of the email formatted for proof-of-delivery.

According to the present disclosure, there is also provided a system for obtaining a proof-of-delivery for a message, comprising:

a message transmission module configured for sending a message;

a proof-of-delivery-request creation module operating remotely from the message transmission module, the proof-of-delivery request creation module being configured for producing a proof-of-delivery-request in response to a request for creating the proof-of-delivery-request, wherein:
the request for creating a proof-of-delivery-request includes the message and meta-data about the message,
the message is encrypted using a symmetric key, thereby producing an encrypted message, and
the proof-of-delivery-request is produced as a function of the symmetric key, the meta-data about the message and a public key;

a proof-of-delivery-request creation trigger module connectable to the proof-of-delivery-request creation module, the proof-of-delivery-request creation trigger module being configured for producing the request for creating the proof-of-delivery-request and substituting the message with a message formatted for proof-of-delivery contemporaneously with the sending of the message, wherein the message formatted for proof-of-delivery is produced by combining the encrypted message with the proof-of-delivery-request;

a proof-of-delivery-request processing module configured for receiving a request for processing a proof-of-delivery-request, retrieving the symmetric key from the proof-of-delivery-request using a private key matching the public key and generating a proof-of-delivery for the message, wherein the request for processing the proof-of-delivery-request includes the proof-of-delivery-request and meta-data about the message;

a message reception module configured for receiving the message formatted for proof-of-delivery; and

a proof-of-delivery-request processing trigger module connectable to the proof-of-delivery-request processing module, the proof-of-delivery-request processing trigger module being configured for triggering the request for processing the proof-of-delivery-request contemporaneously with the reception of the message formatted for proof-of-delivery, receiving the symmetric key from the proof-of-delivery request-processing module and decrypting the encrypted message using said symmetric key.

According to the present disclosure, there is further provided a method for generating a proof-of-delivery for an email, comprising the steps of:

a) generating a request for producing a proof-of-delivery-request contemporaneously with the sending of an email, wherein the email is sent by an email transmission module;

b) producing a proof-of-delivery-request remotely from the email transmission module in response to the request for producing a proof-of-delivery-request;

c) generating a request for processing the proof-of-delivery-request contemporaneously with the reception of the proof-of-delivery-request; and

d) generating a proof-of-delivery remotely from an email reception module in response to a request for processing a proof-of-delivery-request, wherein the generation of the proof-of-delivery is a necessary condition for a recipient to read the email received by the email reception module.

According to the present disclosure, there is also provided a method for generating a proof-of-delivery for an email, comprising the steps of:

a) generating a request for producing a proof-of-delivery-request contemporaneously with the sending of an email, wherein the email is sent by an email transmission module;

b) generating a symmetric key remotely from the email transmission module in response to the request for producing a proof-of-delivery-request;

c) encrypting the email using the symmetric key, thereby obtaining an encrypted email;

d) encrypting the symmetric key using a public key, thereby obtaining an encrypted symmetric key;

e) substituting the email with an email formatted for proof-of-delivery, wherein the email formatted for proof-of-delivery is produced as a function of the encrypted email and the encrypted symmetric key;

f) generating a request for processing the proof-of-delivery-request contemporaneously with the reception of the email formatted for proof-of-delivery by an email reception module;

g) generating a proof-of-delivery remotely from the email reception module in response to the request for processing the proof-of-delivery-request;

h) decrypting the encrypted symmetric key found in the email formatted for proof-of-delivery using a private key, thereby obtaining a decrypted symmetric key; and

i) decrypting the encrypted email found in the email formatted for proof-of-delivery using the decrypted symmetric key.

Preferably, but not necessarily, the sender contacts a proof-of-delivery-request creation server which identifies the sender as being authorized to use its services, receives the message the sender would like to obtain a proof-of-delivery for, generates a symmetric key, encrypts the sender's message with the symmetric key, encrypts the symmetric key and other data items related to the message using a public key associated with the sender or the sender's organization and possibly aggregates this with yet more data items related to the message, thereby creating a proof-of-delivery-request, and returns the encrypted message and the proof-of-delivery-request to the sender. The sender then uses his regular email infrastructure to transmit to the recipient the message and the proof-of-delivery-request as a single email. Upon receiving the sender's email, the recipient contacts a proof-of-delivery-request processing server which has a copy of the private key matching the public key used to create the proof-of-delivery-request, and sends it the proof-of-delivery-request. The proof-of-delivery-request processing server decrypts the encrypted symmetric key found in the proof-of-delivery-request using the private key associated with the sender, notifies the sender that the recipient has received the message and provides the symmetric key back to the recipient which can then decrypt and read the message.

Preferably, but not necessarily, as in co-pending “System and Method for Warranting Electronic Mail Using a Hybrid Public Key Encryption Scheme” assigned PCT International Publication Number WO 2005/078993, in the present disclosure the sender, and/or his organization, does not have access to his private key and cannot, therefore, generate a proof-of-delivery-request for himself. This is an important departure from existing systems which rely on a TTP where the sender generates his own proof-of-delivery-request, some of which were covered earlier. Amongst other things, the use of a proof-of-delivery-request creation server allows the sender's organization to centralize management rules related to the use of this server, and allows for the proof-of-delivery-request creation server to enforce policies on message content. Also, the user can generate proof-of-delivery-requests without having to understand the intricacies of public key infrastructure (PKI), symmetric keys, and hybrid cryptosystems. All he likely needs is a username/password pair and a software component running on his system, possibly a plugin, for interacting with the proof-of-delivery-request creation server.

Preferably, but not necessarily, unlike other TTP-based proof-of-delivery systems, the present disclosure does not rely on the TTP's public key. Instead, a public key associated with the sender is used. In addition to allowing the sender's organization to continue being able to access messages previously processed for proof-of-delivery by a proof-of-delivery-request creation server, possibly using a management console on the proof-of-delivery-request creation server or something similar, the sender and/or his organization need not specify beforehand which TTP must be used by the recipient to process the proof-of-delivery-request. It is, in fact, possible that in a distributed environment, many TTPs may be able to process the proof-of-delivery-request for the recipient, and he can therefore select the one most convenient to his location or his network configuration. In other words, the sender and recipient need not share the same TTP. In terms of scalability and reliability, there are therefore clear advantages to the present disclosure's approach.

Preferably, but not necessarily, the recipient does not need to be known or be identifiable to any TTP. Instead, he just needs the proper software to interact with a TTP's proof-of-delivery-request processing server, possibly a plugin, which could be the same as the one used by the sender. As in examples above, this is a departure from other TTP-based approaches wherein the recipient is assumed to have similar capabilities as the sender, in particular with regards to his having a private/public key pair with the public key being recognized, in some fashion, to match his identity by the TTP.

Preferably, but not necessarily, the email proof-of-delivery system comprises:
the proof-of-delivery-request creation server;
the software used by the sender and the recipient to obtain proof-of-delivery-requests and talk to a TTP's proof-of-delivery-request processing server;
the TTP-operated proof-of-delivery-request processing server; and
all additional software and hardware required to implement the present disclosure.

Other features of the presently disclosed system and method for providing certified proof-of-delivery-receipts for electronic mail will become apparent from the following detailed description taken in conjunction with the accompanying drawings, which illustrate, by way of example, the presently disclosed system and method.

### BRIEF DESCRIPTION OF THE DRAWINGS

A detailed description of preferred embodiments will be given herein below with reference to the following drawings, in which like numbers refer to like elements:

FIG. 1 is a simplified block diagram illustrating an email proof-of-delivery system according to the present disclosure.

FIG. 2 is a block diagram illustrating an embodiment of an email proof-of-delivery system according to the present disclosure, wherein the proof-of-delivery-request creation trigger module is integrated in a sender station, the proof-of-delivery-request creation module is integrated in a proof-of-delivery-request creation server, the proof-of-delivery-request processing trigger module is integrated in a recipient station, and the proof-of-delivery-request processing module is integrated in a proof-of-delivery-request processing server.

FIG. 3 is a block diagram illustrating another embodiment of an email proof-of-delivery system according to the present disclosure, wherein proof-of-delivery-request creation trigger module is integrated in an email transmission module, wherein proof-of-delivery-request processing trigger module is integrated in an email reception module, and wherein the proof-of-delivery is sent as an email to the sender.

FIG. 4 is a block diagram illustrating another embodiment of an email proof-of-delivery system according to the present disclosure, wherein the proof-of-delivery-request is sent to the recipient separately from the email.

FIG. 5 is a block diagram illustrating another embodiment of an email proof-of-delivery system according to the present disclosure, wherein the proof-of-delivery-request reception module is integrated in a proof-of-delivery-request processing server.

FIG. 6 is a block diagram illustrating another embodiment of an email proof-of-delivery system according to the present disclosure, wherein the proof-of-delivery-request is received at a proof-of-delivery-request reception server.

FIG. 7 is a block diagram illustrating another embodiment of an email proof-of-delivery system according to the present disclosure, wherein the proof-of-delivery-request creation trigger module is integrated in a proof-of-delivery-request creation trigger server and the proof-of-delivery-request processing trigger module is integrated in a proof-of-delivery-request reception server.

FIG. 8 is a block diagram illustrating another embodiment of an email proof-of-delivery system according to the present disclosure, wherein the email is sent to the recipient by a proof-of-delivery-request creation server.

FIG. 9 is a block diagram illustrating another embodiment of an email proof-of-delivery system according to the present disclosure, wherein a proof-of-delivery-receipt acknowledgment module and an email recanting module are integrated in a sender station along with the proof-of-delivery-request creation trigger module.

FIG. 10 is a block diagram illustrating another embodiment of an email proof-of-delivery system according to the present disclosure, wherein a proof-of-delivery-request creation server and proof-of-delivery-request processing server are made to be part of a public proof-of-delivery-request services server.

FIG. 11 is a block diagram illustrating the architecture of the Kryptiva™ components commercialized by Kryptiva Inc. which implement an embodiment of an email proof-of-delivery system according to the present disclosure.

FIG. 12 is a network diagram illustrating an example network layout of the Kryptiva™ components as part of a general-purpose network.

FIG. 13 is a block diagram illustrating a modular view of the Kryptiva™ components' embodiment of an email proof-of-delivery system according to the present disclosure.

FIG. 14 is a block diagram illustrating portions of an email proof-of-delivery system, for acknowledging receipt of a proof-of-delivery-receipt email.

FIG. 15 is a block diagram illustrating portions of an email proof-of-delivery system, for recanting a sent email.

FIG. 16 illustrates user interface for configuring general aspects of the Kryptiva Packaging Plugin.

FIG. 17 illustrates a user interface for configuring the server settings in the Kryptiva Packaging Plugin.

FIG. 18 illustrates the Kryptiva™ menu displayed as part of a user's composition window in a typical email client application.

FIG. 19 illustrates a sample email formatted for proof-of-delivery created by the Kryptiva™ components.

FIG. 20 illustrates a the pop-up displayed by the Kryptiva Packaging Plugin for prompting the recipient to allow the proof-of-delivery to be sent to the sender.

FIG. 21 illustrates a sample proof-of-delivery-receipt email created by the Kryptiva™ components.

FIG. 22 illustrates a high-level flowchart of the operation of the proof-of-delivery-request creation trigger module according to the present disclosure.

FIG. 23 illustrates a high-level flowchart of the operation of the proof-of-delivery-request creation module according to the present disclosure.

FIG. 24 illustrates a high-level flowchart of the operation of the proof-of-delivery-request processing trigger module according to the present disclosure.

FIG. 25 illustrates a high-level flowchart of the operation of the proof-of-delivery-request processing module according to the present disclosure.

FIG. 26 illustrates a high-level flowchart of the first part of the creation and sending of an email formatted for proof-of-delivery by the Kryptiva™ components.

FIG. 27 illustrates a high-level flowchart of the second part of the creation and sending of an email formatted for proof-of-delivery by the Kryptiva™ components.

FIG. 28 illustrates a high-level flowchart of the second part of the receiving and processing of an email formatted for proof-of-delivery by the Kryptiva™ components.

### DETAILED DESCRIPTION OF THE PREFERRED EMBODIMENTS

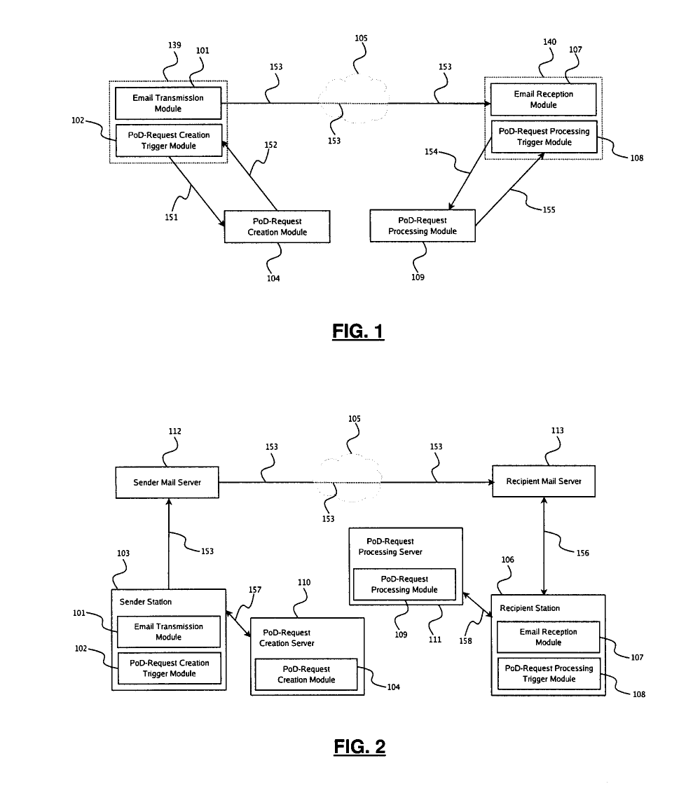

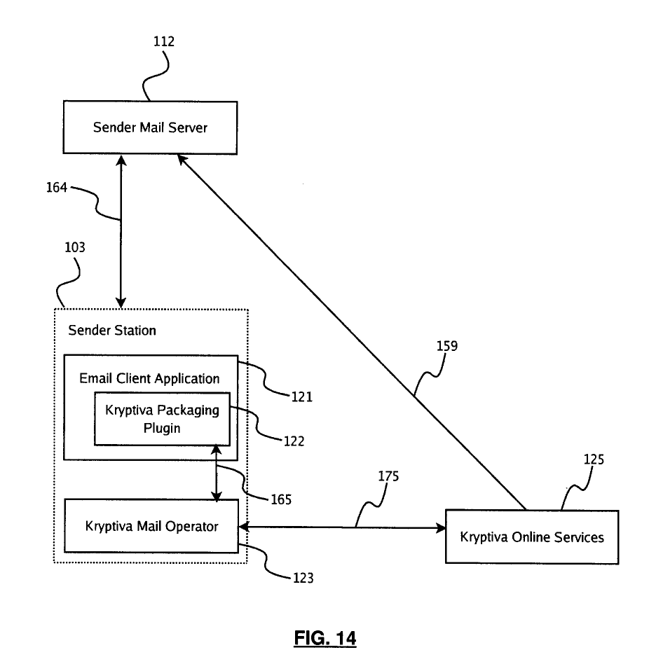

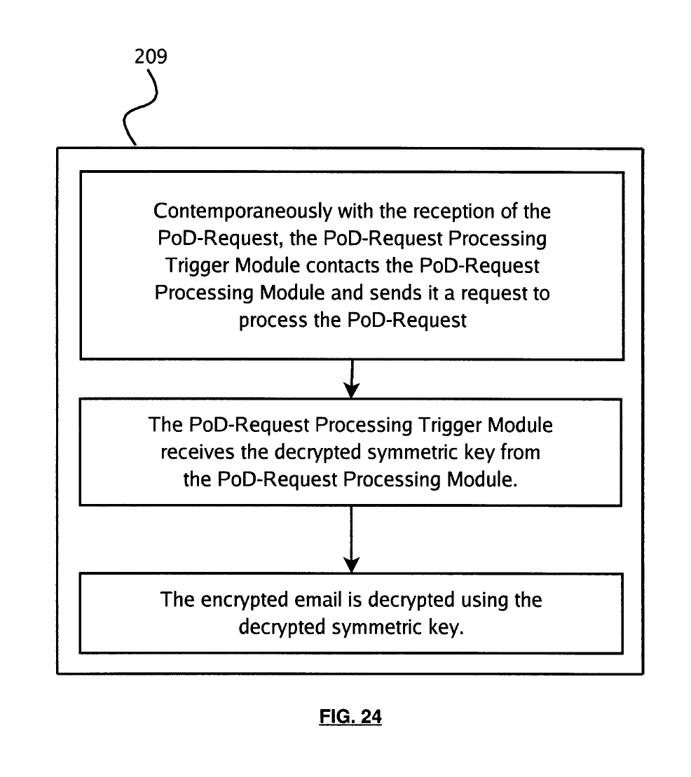

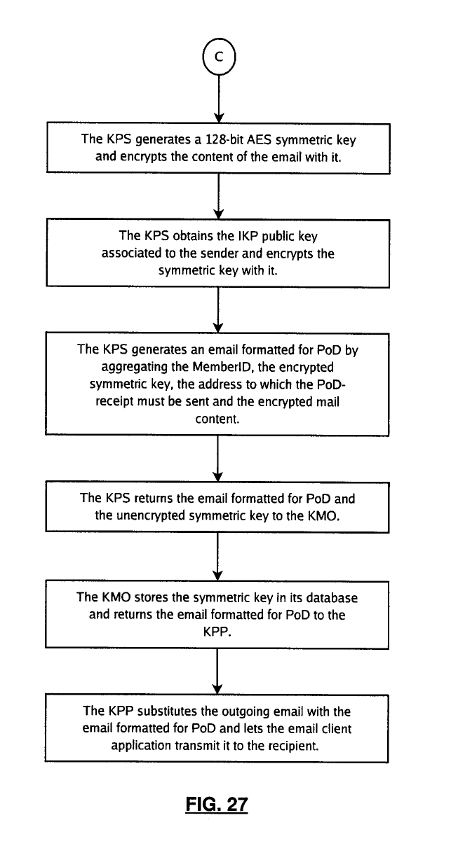

FIG. 1 illustrates the email proof-of-delivery system of the present disclosure enabling a sender to require that a recipient deliver a proof-of-delivery prior to being able to view the email sent by the sender. FIGS. 2 to 10 illustrate possible embodiments of the present disclosure and FIGS. 11 to 21 illustrate the embodiment of the present disclosure by the Kryptiva™ components. FIGS. 22 to 25 illustrate possible embodiments of a proof-of-delivery method of the present disclosure. FIGS. 26 to 28 illustrate the embodiment by the Kryptiva™ components of a proof-of-delivery method according to the present disclosure.

It is hereby noted that for brevity purposes, figures use the acronym “PoD” instead of “proof-of-delivery”. All instances of “PoD” should therefore be read in context as “proof-of-delivery”. For example, “PoD-request” stands for “proof-of-delivery-request”. Also, it is worth noting that in FIGS. 1 to 15, dotted boxes are used for presenting components for which interactions of inner components with external components and other inner components are illustrated. Some components presented may be replaced and other may be added without departing from the teachings of the present disclosure. In FIGS. 1 to 15 and 22 to 28, dotted arrows indicate a set of possibilities.

### First Set of Embodiments

Referring to FIG. 1, the system comprises an email transmission module 101 for sending an email, an email reception module 107 for receiving the email, an proof-of-delivery-request creation trigger module 102 for triggering a request for creating a proof-of-delivery-request, a proof-of-delivery-request creation module 104 for creating the proof-of-delivery-request, an proof-of-delivery-request processing trigger module 108 for triggering the request for processing a proof-of-delivery-request, and a proof-of-delivery-request processing module 109 for processing a proof-of-delivery-request. Preferably, but not necessarily, the email transmission module 101 and the proof-of-delivery-request creation trigger module 102 are aggregated together, possibly along with other modules, into a sender unit 139. Similarly, the email reception module 107 and proof-of-delivery-request processing trigger module 108 are aggregated together, possibly along with other modules, to form a separate recipient unit 140. The proof-of-delivery-request creation module 104 and the proof-of-delivery-request processing module 109, on the other hand, are preferably separate and independent and operate remotely from the previously-mentioned units. With regards to the use of the term “remotely”, it is hereby noted that for a unit designated as “unit A” to operate “remotely” from a unit designated as “unit B”, then data would need cross over a network interface, or an interface similar to a network interface like a USB or FireWire® interface, whether it be physical or virtual, if it were to be transferred back and forth between unit A and unit B; in other words, the services, resources, and/or interfaces of unit B could only be accessed by unit A via a network.

The email is typically sent from the sender unit 139 to the recipient unit 140 (arrow 153), possibly using a network 105. Contemporaneously with the sending of the email by the email transmission module 101, the proof-of-delivery-request creation trigger module 102 contacts the proof-of-delivery-request creation module 104 and sends it a request for creating a proof-of-delivery-request 151. The proof-of-delivery-request creation module 104 creates the proof-of-delivery-request and returns it to the proof-of-delivery-request creation trigger module 102 (arrow 152). Contemporaneously with the reception of the proof-of-delivery-request by the recipient unit 140, the proof-of-delivery-request processing trigger module 108 contacts the proof-of-delivery-request processing module 109 and sends it a request for processing the proof-of-delivery-request 154. The proof-of-delivery-request processing module 109 then processes the proof-of-delivery-request and generates a proof-of-delivery. The proof-of-delivery-request processing module 109 then sends back data regarding the processing of the proof-of-delivery-request to the proof-of-delivery-request processing trigger module 108 (arrow 155), thereby enabling a recipient to view the content of the received email.

In one embodiment, the proof-of-delivery-request creation trigger module 102 sends the email and meta-data about the email as part of the request for creating a proof-of-delivery-request 151 to the proof-of-delivery-request creation module 104. The proof-of-delivery-request creation module 104 then generates a symmetric key, possibly using a random number generator or a pseudo random-number generator, encrypts the email with the symmetric key, encrypts the symmetric key and, possibly, meta-data with a public key associated with the sender, generates a proof-of-delivery-request as a function of the encrypted symmetric key and, possibly, additional meta-data, combines the encrypted email, the proof-of-delivery-request and, possibly, further meta-data thereby generating an email formatted for proof-of-delivery, and returns the email formatted for proof-of-delivery to the proof-of-delivery-request creation trigger module 102 (arrow 152). The email formatted for proof-of-delivery could have also been created by the proof-of-delivery-request creation trigger module 102, provided the proof-of-delivery-request creation module 104 would have returned to it the encrypted email, the proof-of-delivery-request and all additional information, such as meta-data, necessary for generating the email formatted for proof-of-delivery. With the email formatted for proof-of-delivery created, the original email is then substituted with the email formatted for proof-of-delivery and sent by the email transmission module 101 (arrow 153).

At reception, the proof-of-delivery-request is extracted from the email formatted for proof-of-delivery and sent by the proof-of-delivery-request processing trigger module 108 to the proof-of-delivery-request processing module 109 (arrow 154). The proof-of-delivery-request processing module 109 may first verify the proof-of-delivery-request's validity, say by verifying a signature, possibly using a system and method similar to that presented in PCT International Publication Number WO 2005/078993. The proof-of-delivery-request processing module 109 then retrieves the private key matching the public key used to encrypt the symmetric key—possibly from a private key database using meta-data included in the proof-of-delivery-request to identify the key associated to the sender, decrypts the encrypted symmetric key found in the proof-of-delivery-request, creates a proof-of-delivery, and returns the symmetric key to proof-of-delivery-request processing trigger module 108 (arrow 155). The symmetric key can then be used to decrypt the encrypted email received as part of the email formatted for proof-of-delivery. The email in its original format (its format prior to being sent by the proof-of-delivery-request creation trigger module 102 to the proof-of-delivery-request creation module 104) is then available for a recipient to read and a proof-of-delivery has been created to that effect.

The type of meta-data included by the proof-of-delivery-request creation module 104 may include any information that may be relevant to the sender, his organization, the email being sent, the type of content being included, details regarded how, when or how the proof-of-delivery-request was created, etc. Here are a few examples: the sender's email address, the list of recipient addresses, a serial number uniquely identifying the proof-of-delivery-request, the time at which the proof-of-delivery-request was created, an expiry date for the proof-of-delivery-request after which the proof-of-delivery-request processing module 109 should refuse to process it, a unique identifier for identifying the proof-of-delivery-request creation module 104 used to created the proof-of-delivery-request, the format of the encrypted email, the monetary value of the content of the encrypted email, and web URLs. It will be evident to those skilled in the art that other data may be included in the meta-data included by the proof-of-delivery-request creation module 104 without departing from the teachings of the present disclosure.

It could also be possible for the proof-of-delivery-request creation module 104 to return the symmetric key generated as-is back to the proof-of-delivery-request creation trigger module 102 along with the proof-of-delivery-request. The proof-of-delivery-request creation trigger module 102 would then create the encrypted email using that symmetric key and the email formated for proof-of-delivery using the encrypted email and the proof-of-delivery-request. In that case, however, the proof-of-delivery-request may need to include, or be aggregated with, some form of cryptographic hash of the email and there may need to be some form of signing of the proof-of-delivery-request, possibly using a system and method similar to that presented in PCT International Publication Number WO 2005/078993, in order to ensure that there is a match between the email for which the proof-of-delivery-request was created and the encrypted email received by a recipient.

Preferably, but not necessarily, the organization operating a proof-of-delivery-request processing module 109 would be providing proof-of-delivery-request creation modules 104 to client organization. The operating organization would typically create a key pair for each proof-of-delivery-request creation module 104 provided to a client organization. Prior the proof-of-delivery-request creation module 104 being provided to the client organization, said key pair would be encoded into the proof-of-delivery-request creation module 104 and also stored on a key pair database connectable to the proof-of-delivery-request processing module 109, thereby assuring that symmetric keys encrypted using a proof-of-delivery-request creation module's 104 public key can be decrypted the matching private key found in the key pair database by the proof-of-delivery-request processing module 109. Essentially, the operating organization acts as a TTP with regards to its client organizations and all recipients receiving emails formatted for proof-of-delivery sent by those client organizations.

Preferably, but not necessarily, the proof-of-delivery-request processing module 109 accepts anonymous requests for processing proof-of-delivery-requests. This, therefore, allows any recipient, whether they are identifiable or not, to use the proof-of-delivery-request processing module 109 to read emails formatted for proof-of-delivery sent to them.

Typically, the sender unit 139 is any system, device, workstation, server, appliance, computing platform, or hardware capable of transmitting email, regardless of whether it has an active user directly interacting with it at any point in time. One embodiment of the sender unit 139, a sender station 103, is a typical computer system including hardware such as a CPU, or set of tightly-coupled CPUs, RAM, flash, buses, bus controller or controllers, network interface, peripherals and other hardware components, and configured for running software such as an operating system and applications. The sender station 103 may be a fixed computer devices such as a PC workstation running a popular operating system, such as Windows®, MacOS®, or Linux®, or it may be a portable device such as a Blackberry®, Palm® Treo™, or a generic device running an embedded operating system, such as Symbian® or Windows® Mobile™, or it may be a server system, or a set of aggregated servers, running a server operating system, such as Windows® Server or Red Hat® Linux®, or it may be any such similar system.

Similarly to the sender unit 139, the recipient unit 140 may be any system, device, workstation, server, appliance, computing platform, or hardware capable of transmitting email, regardless of whether it has an active user directly interacting with it at any point in time. One embodiment of the recipient unit 140 is a recipient station 106 having similar characteristics as the sender station 103.

FIG. 2 illustrates another embodiment of the email proof-of-delivery system according to the present disclosure. In this embodiment, the email transmission module 101 and the proof-of-delivery-request creation trigger module 102 are integrated in the sender station 103 and the email reception module 107 and proof-of-delivery-request processing trigger module 108 are integrated in the recipient station 106. In this case, the email transmission module 101 and email reception module 107 may be any application capable of sending and/or receive email. This includes typical email client applications used by users to retrieve/read/send email, such as Eudora®, Outlook®, Mozilla Thunderbird™, Lotus® Notes, and others. The email transmission module 101 and email reception module 107 may also be a web browser, such as Internet Explorer™ or Mozilla Firefox™, when said web browser is being used by a user to access an online web-mail account, such as Yahoo!® Mail, Hotmail™, Gmail™, and others. The email transmission module 101 may also be server software configured for sending email in an automated fashion, such as a website script or program configured for sending email in response to a command, or a series of commands, effected by a user on a website or a server script configured for sending email to notify the recipient of some critical event on the server. Conversely, the email reception module 107 may be a server software configured for receiving and processing email in an automated fashion, such as a mailing list subscribing software or a script for processing incoming user complaints or feedback.

Still in this embodiment, the proof-of-delivery-request creation trigger module 102 is software running alongside the email transmission module 101 on the sender station 103, possibly interfacing with the email transmission module 101 in order to create proof-of-delivery-requests for all or some of the outgoing emails. Similarly, the proof-of-delivery-request processing trigger module 108 is software running alongside the email reception module 107 on the recipient station 106, possibly interfacing with the email reception module 107 in order to process some or all of incoming emails formatted for proof-of-delivery. Typically, the proof-of-delivery-request creation trigger module 102 and proof-of-delivery-request processing trigger module 108 would be add-on software to the email transmission module 101 and email reception module 107, respectively. The proof-of-delivery-request creation trigger module 102 and proof-of-delivery-request processing trigger module 108 may, for example, be implemented as plugins to email clients and web browsers, or be implemented as extensions to server software. The extent and fashion of the integration and interaction between the proof-of-delivery-request creation trigger module 102 and the email transmission module 101 and the proof-of-delivery-request processing trigger module 108 and the email reception module 107 may vary greatly without departing from the teachings of the present disclosure. For example, the proof-of-delivery-request creation trigger module 102 may be an integral part of the email transmission module 101 and the proof-of-delivery-request processing trigger module 108 may be an integral part of the email reception module 107 as in FIG. 3. Also, the proof-of-delivery-request creation trigger module 102 and the proof-of-delivery-request processing trigger module 108 may be implemented as the same plugin, wherein the plugin's functionality depends on whether it is used to create proof-of-delivery-requests for outgoing email or to process incoming proof-of-delivery-requests or incoming emails formatted for proof-of-delivery. The proof-of-delivery-requests generated by proof-of-delivery-request creation modules 104 would likely contain plain-text messages so that recipients that lack the software required to deal with proof-of-delivery-requests could still be informed of the functionality and how they could obtain the software required to deal with proof-of-delivery-requests and emails formatted for proof-of-delivery.

Still in the embodiment illustrated in FIG. 2, the proof-of-delivery-request creation module 104 is integrated in a proof-of-delivery-request creation server 110 and the proof-of-delivery-request processing module 109 is integrated in a proof-of-delivery-request processing server 111. The proof-of-delivery-request creation server 110 may either be on the local network of the sender station 103 or be outside the perimeter of the local firewall. Similarly, the proof-of-delivery-request processing server 111 may either be on the local network of the recipient station 106 or be outside the perimeter of the local firewall. In the preferred embodiment, the proof-of-delivery-request processing server 111 is typically a server, or a set of servers, publicly available on the Internet 126, but other configurations are also possible, including having a local proof-of-delivery-request processing server 111 acting as a proxy for or reporting to a higher-level proof-of-delivery-request processing server 111. The location and actual system configuration or layering of the proof-of-delivery-request creation server 110 and proof-of-delivery-request processing server 111 do not modify their behavior. Typically, however, the sender station 103 is connected to the proof-of-delivery-request creation server 110 and the recipient station 106 is connected to the proof-of-delivery-request processing server 111. Generally these connections are by way of a network interface, but other configurations are also possible such as using a peripheral bus like USB or FireWire®. There is, in fact, nothing precluding the proof-of-delivery-request creation server 110 from being a device attached to the sender station 103 via a USB bus.

Generally, both the proof-of-delivery-request creation server 110 and proof-of-delivery-request processing server 111 are running a hardened operating system such as Linux®, Solaris® or AIX®. As such, the proof-of-delivery-request creation module 104 and proof-of-delivery-request processing module 109 are typically implemented as software using the secure socket layer (SSL) API to receive and respond to outside requests, and operating system APIs for spawning tasks and threads and controlling the execution of threads and processes servicing existing requests. Furthermore, the software implementation of the proof-of-delivery-request creation module 104 and the software implementation of the proof-of-delivery-request processing module 109 may interact with local services such as syslog for logging key events and use a database for storing and retrieving data. Said database could be used for adding functionality to the basic architecture of the present disclosure. For example, by storing proof-of-delivery-request serial numbers in the database, it can be made possible to provide functionality such as email recanting and sender-acknowledged proof-of-delivery, as is discussed further below. Typically, both the proof-of-delivery-request creation module 104 software and proof-of-delivery-request processing module 109 software operate automatically without requiring direct human intervention on the server running the software, though software or interfaces may be provided for facilitating the set up of such software and servers. Also, the software implementation of the proof-of-delivery-request creation module 104 and the software implementation of the proof-of-delivery-request processing module 109 use a cryptographic library for implementing the cryptographic functionality associated with proof-of-delivery-requests.

Still in the embodiment illustrated in FIG. 2, the proof-of-delivery-request creation trigger module 102 is activated contemporaneously with the sending of the email by the email transmission module 101. If the proof-of-delivery-request creation trigger module 102 is a plugin to an email client application 121 for example, the proof-of-delivery-request creation trigger module 102 would be activated when the user would click on the “Send” button of his email client application 121. Because the actual time at which an email is truly “sent” on the sender station 103 could, nevertheless, be subject to interpretation, it is assumed in this embodiment that the email leaving the sender station 103 for the sender mail server 112 has been processed for proof-of-delivery if it needed to be. The proof-of-delivery-request creation trigger module 102 communicates with the proof-of-delivery-request creation server 110 (arrow 157) to create an email formatted for proof-of-delivery and substitutes the outgoing email with the email formatted for proof-of-delivery which is then itself sent to the sender mail server 112 from the sender station 103. The sender mail server 112 then transmits the email formatted for proof-of-delivery to the recipient mail server 113, possibly through a network 105 or a set of interlinked networks and mail servers. The email is then retrieved from the recipient mail server 113 by the email reception module 107 (email “pull”) or sent by the recipient mail server 113 to the recipient station 106 (email “push”).

Typically, the proof-of-delivery-request processing trigger module 108 software interacts with the email reception module 107 software to detect incoming email formatted for proof-of-delivery. If the proof-of-delivery-request processing trigger module 108 is a plugin, for example, this may involve the proof-of-delivery-request processing trigger module 108 hooking itself into the receive functionality of the email client application 121 or hooking itself on the email client application 121 functionality for adding incoming emails to email existing folders. Having determined that an incoming email is an email formatted for proof-of-delivery, the proof-of-delivery-request processing trigger module 108 typically extracts the proof-of-delivery-request from the email formatted for proof-of-delivery and communicates with the proof-of-delivery-request processing server 111 (arrow 158) in order to obtain a decrypted copy of the encrypted symmetric key found in the proof-of-delivery-request. Using the returned symmetric key, the proof-of-delivery-request processing trigger module 108 can then decrypt the encrypted email found in the email formatted for proof-of-delivery and make it available either directly to the recipient or make it available to the email reception module 107 which would then be used by the recipient to view and process the email.

In order to return the symmetric key found in encrypted form in the proof-of-delivery-request, the proof-of-delivery-request processing module 109 running on the proof-of-delivery-request creation server 110 would typically first verify the integrity of the proof-of-delivery-request, possibly by verifying its authenticity as explained earlier. The proof-of-delivery-request processing module 109 would then retrieve the private key matching the public key used to encrypt the symmetric key during the packaging of the proof-of-delivery-request and decrypt the encrypted symmetric key. Prior to returning the symmetric key to the proof-of-delivery-request processing trigger module 108, the proof-of-delivery-request processing module 109 would first effectively create a certified proof-of-delivery-receipt. This proof-of-delivery-receipt may itself take a number of different forms, including an email sent to the original sender—who's address may be made to be part of the meta-data packaged as part of the proof-of-delivery-request at the time it is created by the proof-of-delivery-request creation module 104—, a GSM SMS message to a cellphone, a record in a database for display via a website page, a printed record. It may also be desirable to further deliver the proof-of-delivery-receipt to the sender using a mechanism so as to trigger a signal back to the proof-of-delivery-request processing module 109 acknowledging that the sender has received his proof-of-delivery-receipt. For example, the certified proof-of-delivery-receipt sent to the sender may itself be an email formatted for proof-of-delivery, though in this case the processing of the designated proof-of-delivery-request would only serve to notify the proof-of-delivery-request processing module 109 that the certified has been received by the sender. Such hardened functionality for ensuring the delivery of certified proof-of-delivery-receipts could be used for enhancing the functionality of the proof-of-delivery-request processing module 109 in order to retry proof-of-delivery-receipt transmission or to use an alternative mechanism for allowing the sender to be notified that his email has indeed been received. It may further be desirable for hosting a database connectable to the proof-of-delivery-request processing module 109 for temporarily storing data uniquely identifying proof-of-delivery-requests processed by the proof-of-delivery-request processing module 109 in order to allow sender to manually inquire about the status of the processing of the proof-of-delivery-request.

Referring to the embodiment illustrated in FIG. 3, the email transmission module 101 integrates the functionality typically implemented by the proof-of-delivery-request creation trigger module 102 and the email reception module 107 integrates the functionality typically implemented by the proof-of-delivery-request processing trigger module 108. Also, the proof-of-delivery-request creation module 104 operates remotely from the email reception module 107 and the proof-of-delivery-request processing module 109 operates remotely from the email reception module 107.

In this embodiment, the email transmission module 101 contacts the proof-of-delivery-request creation module 104 to obtain a proof-of-delivery-request 151. First, the email transmission module 101 must provide the proper information in order to obtain the authorization to use the proof-of-delivery-request creation module 104. This information may be a username/password pair, or it may be a function of the network layout, such as an IP address or a MAC address, or both, or something else. The proof-of-delivery-request creation module 104 may also be configured to accept connections from any senders with access to it. Having been authorized to use the proof-of-delivery-request creation module's 104 services, the sender transmits the messages he wishes to obtain a proof-of-delivery-request for to the proof-of-delivery-request creation module 104. Note that proof-of-delivery-request creation module 104 could be located on a sender's organization's LAN or it could be remotely accessible through another network such as the Internet. The functionality of the proof-of-delivery-request creation module 104 should be fairly similar whether it is on local LAN or on a remote network.

The proof-of-delivery-request creation module 104 receives the message and likely stores it in a temporary buffer in RAM for further processing. The proof-of-delivery-request creation module 104 could then conduct a series of analysis on the message, including verifying compliance to corporate guidelines and spam detection, amongst other possibilities. Having done so, the proof-of-delivery-request creation module 104 generates a random symmetric key and encrypts the message with this key. The proof-of-delivery-request creation module 104 then generates a proof-of-delivery-request by encrypting the symmetric key possibly along with other data items related to the message using a public key attributed to the sender or his organization. The proof-of-delivery-request creation module 104 could also conduct a number of other operations on the message, such as generating a signature for the sender akin the description found in co-pending PCT International Publication Number WO 2005/078993, or it may even encrypt the message for exclusive viewing by a recipient.

The proof-of-delivery-request creation module 104 then returns the encrypted message and the proof-of-delivery-request to the email transmission module 101 (arrow 152). The email transmission module 101 then transmits the encrypted message and the proof-of-delivery-request as a regular email to the sender mail server 112 (arrow 153). In turn, the sender mail server 112, transmits the email to the recipient mail server 113 (arrow 153).

Next, the email reception module 107 retrieves messages stored for it by the recipient mail server 113 (arrow 156). At this stage the email reception module 107 would detect emails containing proof-of-delivery-requests and act appropriately. It could be possible for the email reception module 107 to request input from the user as to whether he desires to in fact participate in the proof-of-delivery process or whether he wishes not to, in which case he would be unable to read the message.

The email reception module 107 then contacts the proof-of-delivery-request processing module 109 in order to obtain the decrypted symmetric key 154. This process does not require the recipient to be a party known to or identifiable by the proof-of-delivery-request processing module 109. Instead, any recipient can interact with the proof-of-delivery-request processing module 109 to request the processing of proof-of-delivery-requests. As part of this process, the recipient transmits the proof-of-delivery-request received to the proof-of-delivery-request processing module 109.

The proof-of-delivery-request processing module 109 then processes the proof-of-delivery-request obtained from the email reception module 107. The essential task of the proof-of-delivery-request processing module 109 at this stage is to identify the proof-of-delivery-request creation module 104 used to create the proof-of-delivery-request, retrieve the private key related to this proof-of-delivery-request creation module 104 from a private key database, decrypt the encrypted symmetric key found in the proof-of-delivery-request using the retrieved private key, and create a certified proof-of-delivery-receipt. The proof-of-delivery-request processing module 109 may, however, do much more. First, the certified proof-of-delivery-receipt created could likely be signed by the proof-of-delivery-request processing module 109 thereby attesting to its origin and validity, possibly using the process described in co-pending PCT International Publication Number WO 2005/078993. Secondly, the email reception module 107 may have the ability to inform the proof-of-delivery-request processing module 109 of messages it wishes to “retract” or “recant”. In such a case, the proof-of-delivery-request processing module 109 would refuse to provide the email reception module 107 with the symmetric key for decrypting the message, thereby making the message unreadable. Thirdly, the proof-of-delivery-request processing module 109 could be made to log as much information about the email reception module 107 as possible. For example, the email reception module's 107 IP address and the time at which the proof-of-delivery-request was transmitted could be logged as part of data stored for or later transmitted as part of the proof-of-delivery-receipt. Fourthly, the proof-of-delivery-request processing module 109 could be configured to only allow one proof-of-delivery-request through. In other words, only the first email reception module 107 sending a request for processing a proof-of-delivery-request would be allowed, subsequent requests for processing the same proof-of-delivery-request from other email reception modules 107 or recipients would result in the proof-of-delivery-request processing module 109 refusing to give them the symmetric key. There are, of course, many other enhancements possible to the proof-of-delivery-request processing module's 109 use in the scheme described in the present disclosure.

Having processed the proof-of-delivery-request, the proof-of-delivery-request processing module 109 sends the certified proof-of-delivery-receipt to the sender 159. In this illustration, the certified proof-of-delivery-receipt is illustrated as being sent as a regular email back to the sender. However, the certified proof-of-delivery-receipt could be transmitted using other means, including storing it in a database for the sender to consult online, as mentioned earlier, or transferring certified proof-of-deliverys in batches back to the sender.

The proof-of-delivery-request processing module 109 then transfers the decrypted symmetric key to the email reception module 107 (arrow 155). Having received the decrypted symmetric key, the email reception module 107 can then decrypt the message and read it.

Finally, the email reception module 107 retrieves the sender's emails from the sender mail server 112 and obtains the certified proof-of-delivery-receipt 164. As explained earlier, it is important to note that the sender could be provided with other means for obtaining or viewing certified proof-of-delivery-receipts.

In addition and as a complement to other descriptions to that effect in the present disclosure, it is hereby noted the request for creating a proof-of-delivery request 151 may include, amongst other possible data items, the following: the address at which the sender would like to received the proof-of-delivery receipt, the email for which a proof-of-delivery-request is to be created along with all of its fields, an expiry date after which the proof-of-delivery-request should not be requested by the proof-of-delivery-request processing module 109, and all other data items relevant or required for implementing an embodiment of the present disclosure. Similarly, it is hereby noted the request for processing a proof-of-delivery request 154 may include, amongst many other data items, the following: the proof-of-delivery-request to be processed, the recipient's claimed email address, the subject line as seen by the recipient, the IP address of the recipient, and all other data items relevant or required for implementing an embodiment of the present disclosure.

### Second Set of Embodiments

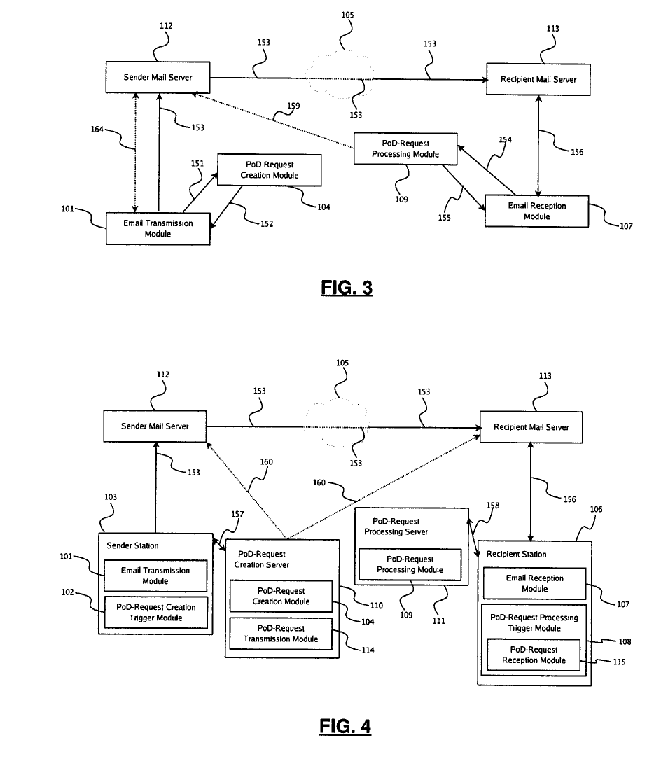

FIGS. 4 to 7 illustrate other possible embodiments of email proof-of-delivery system according to the present disclosure. In these embodiments there is a proof-of-delivery-request transmission module 114 and a proof-of-delivery-request reception module 115. In the embodiments illustrated in FIGS. 1 to 3, the proof-of-delivery-request transmission module's 114 functionality was fully integrated in either the proof-of-delivery-request creation trigger module 102, the proof-of-delivery-request creation module 104 or the email transmission module 101, and the proof-of-delivery-request reception module's 115 functionality was fully integrated in either the proof-of-delivery-request processing trigger module 108 or the email reception module 107. Typically, though not necessarily, embodiments having an explicit proof-of-delivery-request transmission module 114 or an explicit proof-of-delivery-request reception module 115 have separate paths for the proof-of-delivery-request and the encrypted email. This approach, however, further introduces the requirement for providing means for matching proof-of-delivery-requests to encrypted emails. This can be implemented as a signed serial number, for example.

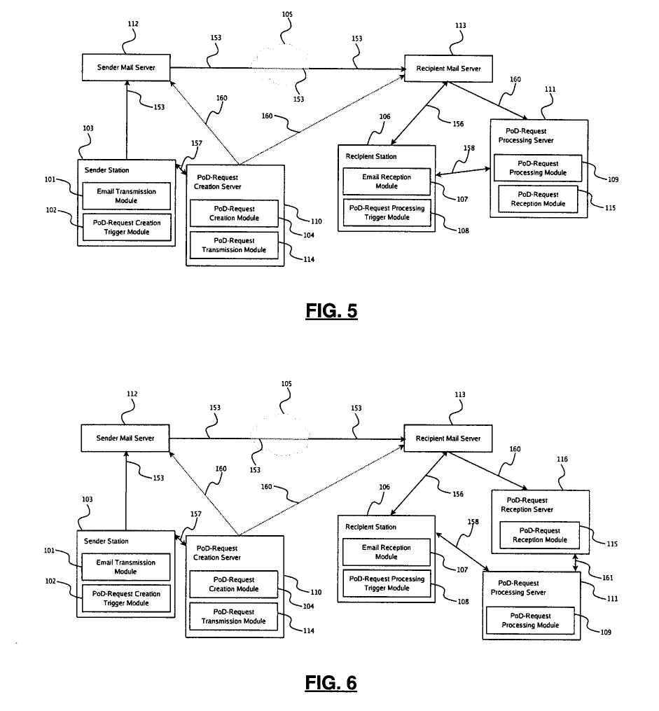

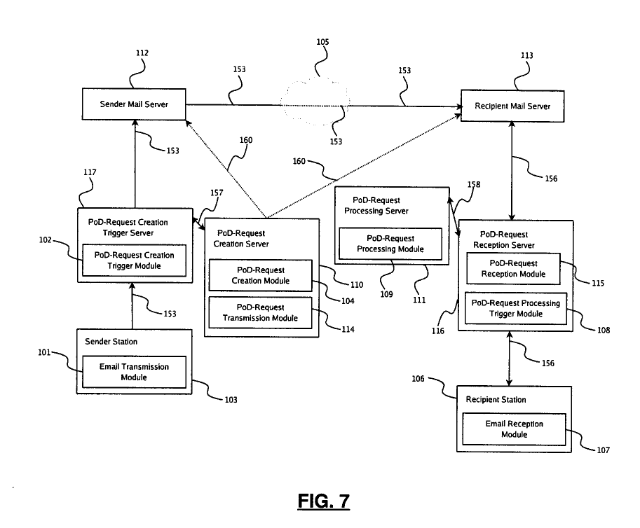

In the embodiment illustrated in FIG. 4, for example, the proof-of-delivery-request is sent directly to the recipient, or recipients, by the proof-of-delivery-request creation server 110 either through the sender mail server 112 or the recipient mail server 113 (arrow 160). In this case, the proof-of-delivery-request reception module 115 is integrated int the proof-of-delivery-request processing trigger module 108 for transmitting the request for processing the proof-of-delivery-request when said proof-of-delivery-request is received by the proof-of-delivery-request reception module 115. This may be a useful configuration if there were a requirement for withholding the proof-of-delivery-request at the proof-of-delivery-request creation server 110 pending the completion of a transaction, say, for example, the payment for the content in the encrypted email. In the embodiment illustrated in FIG. 5, the proof-of-delivery-request is again sent by the proof-of-delivery-request creation module 104, but here the recipient mail server 113 transmits the proof-of-delivery-request to the proof-of-delivery-request processing server 111 instead of it being received by the recipient station 106. This may be a useful configuration for organizations wishing to have tight control over incoming emails which require employees to provide a proof-of-delivery, say for example in order to record or log these occurrences in a database for compliance purposes. A drawback of this approach is that it would be impractical if the proof-of-delivery-request processing server 111 were globally shared by all recipients. The embodiment illustrated in FIG. 6 partially remedies to this by introducing a proof-of-delivery-request reception server 116 which deals only with storing incoming proof-of-delivery-requests and communicates with the proof-of-delivery-request processing server 111 for synchronizing for the processing of proof-of-delivery-requests 161. In both embodiments illustrated in FIGS. 5 and 6, communication between the recipient station 106 and the proof-of-delivery-request processing server 111 (arrow 158) requires that the proof-of-delivery-request processing trigger module 108 provide the proof-of-delivery-request processing module 109 with information for it to locate the proof-of-delivery-request matching a given encrypted email processed by the proof-of-delivery-request processing trigger module 108, which may be the signed serial number mentioned earlier. In other words, this would require the proof-of-delivery-request creation module 104 to attribute a unique serial number to each encrypted email and proof-of-delivery-request pair so that they could be paired again if sent separately.

In the embodiment illustrated in FIG. 7, the sender station 103 and recipient station 106 remain unchanged with the introduction of the proof-of-delivery-request creation trigger module 102 and the proof-of-delivery-request processing trigger module 108. Instead, the path of the email as it is sent from the sender station 103 to the sender mail server 112 is made to include a proof-of-delivery-request creation trigger server 117 in which the proof-of-delivery-request creation trigger module 102 is integrated, and the path of the email as it is transferred from the recipient mail server 113 to the recipient station 106 is made to include a proof-of-delivery-request reception server 116 in which the proof-of-delivery-request reception module 115 and the proof-of-delivery-request processing trigger module 108 are integrated. In this configuration, the proof-of-delivery-request creation trigger server 117 substitutes the email sent by the sender station 103 with an email formatted for proof-of-delivery and the proof-of-delivery-request creation server 110 automatically processes the email formatted for proof-of-delivery received from the recipient mail server 113 and substitutes it with the original email and sends it to the recipient station 106 instead of the email formatted for proof-of-delivery. This configuration may be of interest in organizations having close ties in which both organization agree to automatically acknowledge proof-of-delivery for all of the other organization's emails.

### Third Set of Embodiments

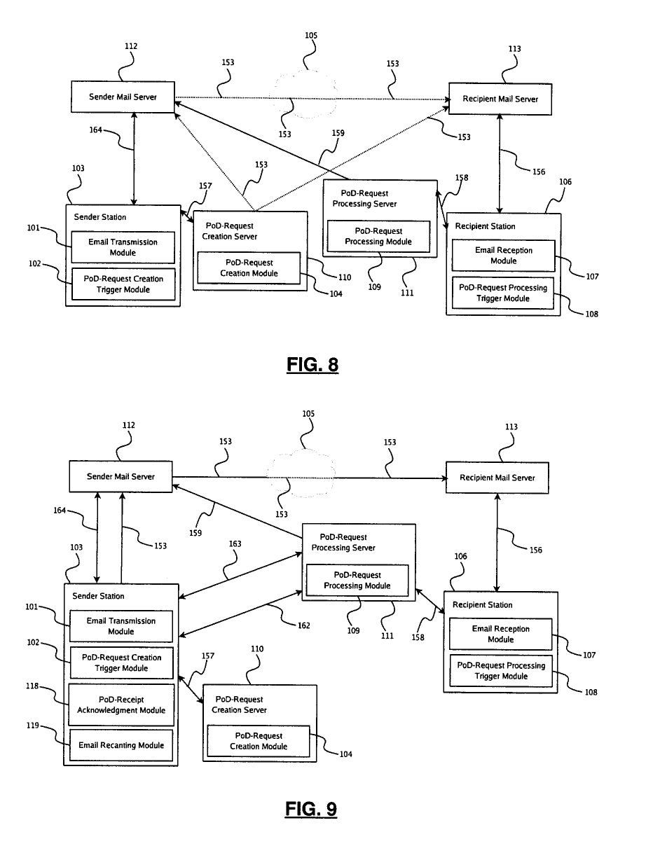

In the embodiment illustrated in FIG. 8, the proof-of-delivery-request creation server 110 sends the email directly to the recipient 153 in response to a request for creating a proof-of-delivery-request. This configuration may be of interest if the organization using the proof-of-delivery-request creation server 110 would wish to reduce its network bandwidth usage and avoid having the email formatted for proof-of-delivery returned to the sender station 103 prior to being sent to the sender mail server 112.

The embodiment illustrated in FIG. 9 further includes a proof-of-delivery-receipt acknowledgment module 118 and a email recanting module 119. The proof-of-delivery-receipt acknowledgment module 118 enables the sender to inform the proof-of-delivery-request processing server 111 that he has indeed received the proof-of-delivery-receipt sent to him in response to an earlier sent email formatted for proof-of-delivery. In other words, this is form of proof-of-delivery-receipt reception acknowledgment. The email recanting module 119 enables the sender to inform the proof-of-delivery-request processing server 111 that he wishes to recant, recall or retract an email for which he had requested a proof-of-delivery.

In order for the acknowledgment mechanism to be effective, the proof-of-delivery-request processing server 111 preferably maintains a database of those proof-of-delivery-receipts that were sent and for which there have not yet been acknowledgment; a proof-of-delivery-request serial number included in the proof-of-delivery-request meta-data by the proof-of-delivery-request creation module 104 at proof-of-delivery-request creation time could be used as the primary key for identifying proof-of-delivery-request entries in said database. A background task on the proof-of-delivery-request processing server 111 may then automatically run from time to time to check for those proof-of-delivery-receipts sent for which there have not yet been acknowledgment and proceed to act accordingly. One possible behavior is the escalation of the “problem” to a human who could then call the sender and deliver a proof-of-delivery in person over the phone. Of course such an acknowledgment procedure may be entirely optional and the sender may be given the option to require such acknowledgment. Also, if this is sold as part of a service, a premium may be charged for delivering such functionality to the sender. Capabilities may also be provided to the sender for manually checking the proof-of-delivery-request processing server's 111 pending proof-of-delivery-receipts database for proof-of-delivery-receipts he has not yet received. Preferably, but not necessarily, the proof-of-delivery-receipt acknowledgment module 118 receives a proof-of-delivery-receipt which is itself an email formatted for proof-of-delivery. Contrary to other emails formatted for proof-of-delivery, the processing the proof-of-delivery-receipt would itself not generate a proof-of-delivery-receipt by the proof-of-delivery-request processing server 111. Instead, when receiving the proof-of-delivery-receipt acknowledgment 163, the proof-of-delivery-request processing server 111 would delete the designed proof-of-delivery-receipt from its database of pending proof-of-delivery-receipt acknowledgments. Typically, the proof-of-delivery-receipt acknowledgment module 118 is implemented as part of the plugin implementing the proof-of-delivery-request creation trigger module 102.

The recant functionality of the email recanting module 119 may also be implemented by way of a database connectable to the proof-of-delivery-request processing server 111. In this case, the proof-of-delivery-requests would preferably be assigned a time-to-live along with a creation time or, alternatively, an expiry date by the proof-of-delivery-request creation module 104 at proof-of-delivery-request creation time. That way, the proof-of-delivery-request processing module 109 on the proof-of-delivery-request processing server 111 can determine whether the proof-of-delivery-request being handed to it as part of a request for processing a proof-of-delivery-request is still valid. If it weren't, the proof-of-delivery-request processing module 109 would then respond to the proof-of-delivery-request processing trigger module 108 informing it that proof-of-delivery-request processing has been refused. For this functionality to be effective there would need to be some form of time validation on both the proof-of-delivery-request creation server 110 and proof-of-delivery-request processing server 111. This doesn't necessarily mean the use of any time synchronizing mechanism in between the two, though this could be possible, nor necessarily involve the use of an absolute time reference, though this too could be possible. In other words, while a protocol such as the Network Time Protocol (NTP) could be used by both the proof-of-delivery-request creation server 110 and proof-of-delivery-request processing server 111 to synchronize their clock, other means, including ad-hoc solutions, could be used to ensure some reasonable time validation on both the proof-of-delivery-request creation server 110 and proof-of-delivery-request processing server 111, other safeguards being put in place to avoid potential security holes. For example, the proof-of-delivery-request creation server 110 may be made to require that proof-of-delivery-request creation trigger modules 102 requesting proof-of-delivery-requests also send the current time of the sender station 103. The proof-of-delivery-request creation server 110 can then, at the time of an incoming request, use heuristics to determine whether its time-base is skewed in reference to the clock times given to it by various sender stations 103 as part of the past requests for creating a proof-of-delivery-request it has received over a given period of time. For the proof-of-delivery-request processing server 111, on the other hand, some global time-base, such as a GPS-based clock.

Along with determining whether a proof-of-delivery-request has expired, the proof-of-delivery-request processing server 111 would preferably be connectable to a proof-of-delivery-request status database for storing the serial numbers of the proof-of-delivery-requests that have been processed for a given period of time. Each proof-of-delivery-request serial number would have a separate entry in the database along with a processing status. This database would be consulted by the proof-of-delivery-request processing module 109 prior to processing any proof-of-delivery-request. If no entry exists for the proof-of-delivery-request provided to the proof-of-delivery-request processing module 109 as part of a request for processing a proof-of-delivery-request, an entry would be created marking the proof-of-delivery-request as having been “processed”. Later, if the sender, by way of an email recanting module 119, were to attempt to recant the proof-of-delivery-request 162 having the same serial number, the proof-of-delivery-request processing server 111 would inform it that the email cannot be recanted or that it could be recanted but has already been read by at least one recipient. Conversely, if a sender were to recant an email 162 for which the corresponding proof-of-delivery-request does not yet have an entry in the database, an entry would be created for that proof-of-delivery-request in the database and marked as “recanted”. Later, if a recipient were to send a request for processing a proof-of-delivery-request for that given serial number, it would be informed that processing is no longer possible since the email has been recanted and, therefore, the recipient would be unable to read the email.

Preferably, but not necessarily, senders must first obtain an authorization token, possibly in the form of signed or encrypted data, from the proof-of-delivery-request creation module 104 for recanting previously created proof-of-delivery-requests and then provide this authorization token to the proof-of-delivery-request processing server 111 in order to effect the email recanting. In turn, the proof-of-delivery-request processing server 111 would verify the validity of the token prior to carrying out the actual addition of the proof-of-delivery-request's serial number to the proof-of-delivery-request status database.

For tolerance purposes, proof-of-delivery-requests could be created for lasting a finite amount of days by the proof-of-delivery-request creation server 110, but the proof-of-delivery-request processing server 111 could be made to store the serial numbers of the proof-of-delivery-requests it has been asked to process for twice that amount of time starting at the time it was first request to process a proof-of-delivery-request having a given serial number. If the proof-of-delivery-requests are valid for 30 days, for example, the proof-of-delivery-request processing server 111 could be made to hold a given proof-of-delivery-request's serial number and status for 60 days starting at the time it was first requested to process such a proof-of-delivery-request. This will safeguard from the case where the proof-of-delivery-request creation server 110 time is slightly in advance of the proof-of-delivery-request processing server 111 time, while not allowing the proof-of-delivery-request status database to grow uncontrollably should a lot of proof-of-delivery-request creation servers 110 have their time-base in advance of the proof-of-delivery-request processing server 111 time-base.

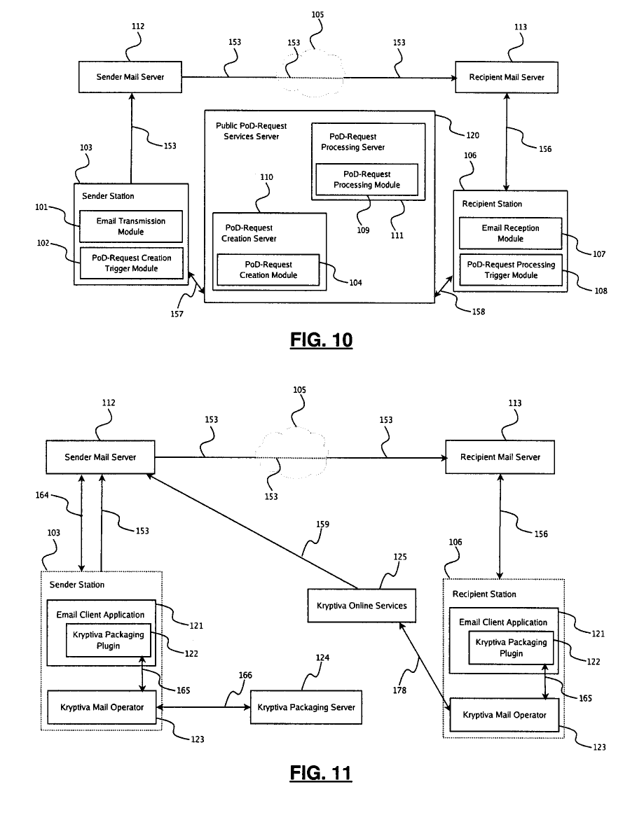

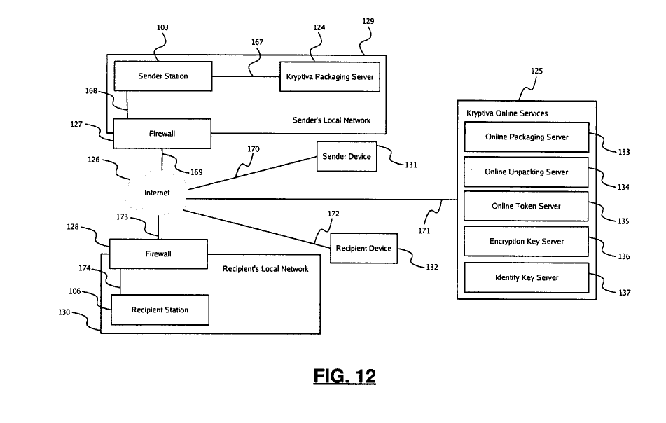

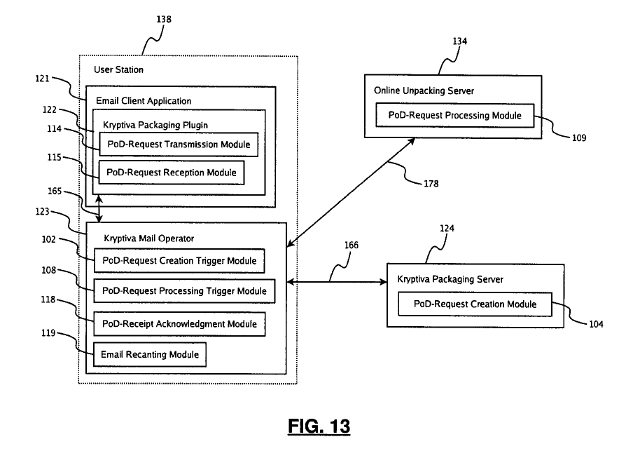

FIG. 10 illustrates an embodiment of the present disclosure where the proof-of-delivery-request creation server 110 and the proof-of-delivery-request processing server 111 are made to appear as a single network service, the public proof-of-delivery-request services server 120. This configuration may be of interest if the email proof-of-delivery system according to the present disclosure were to be made available via an online subscription.

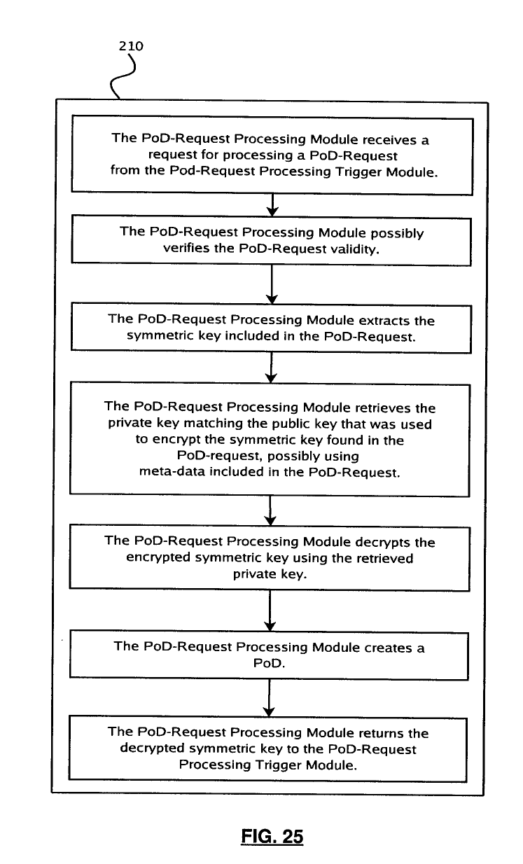

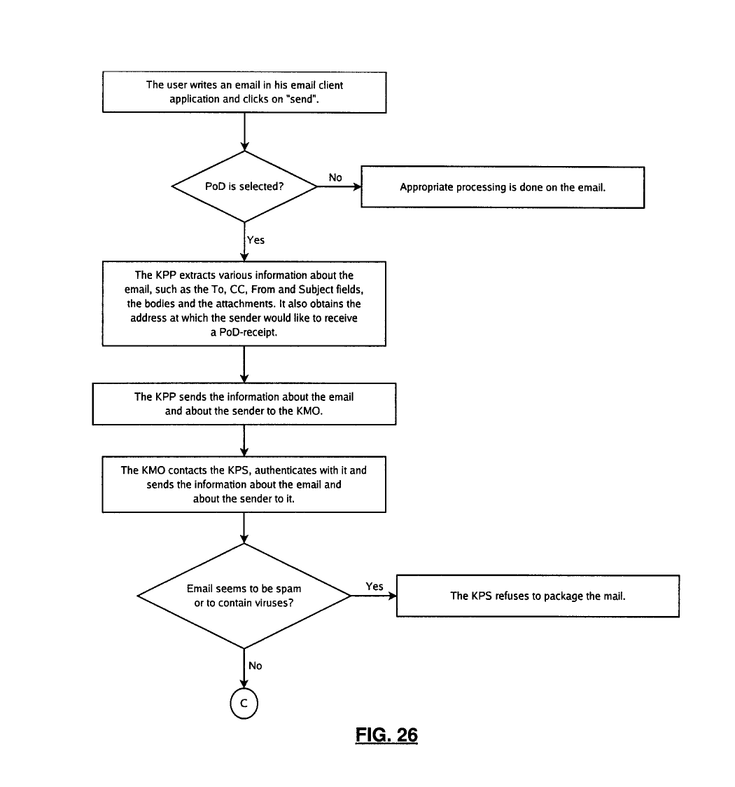

FIGS. 22 to 25 summarize the email proof-of-delivery method according to the present disclosure. In FIG. 22, the proof-of-delivery-request creation trigger module 102 starts by contacting the proof-of-delivery-request creation module 104 (steps in 201). The subsequent operation depends the actual system configuration with the proof-of-delivery-request creation module 104 either returning the email formatted for proof-of-delivery to the proof-of-delivery-request creation trigger module 102 (steps in 202), or returning the encrypted email and the proof-of-delivery-request for the proof-of-delivery-request creation trigger module 102 to create the email formatted for proof-of-delivery (steps in 203), or the proof-of-delivery-request creation module 104 sending the proof-of-delivery-request separately from the encrypted email (steps in 204 and in 205). In FIG. 23, the proof-of-delivery-request creation module 104 starts by receiving a request for creating a proof-of-delivery-request from the proof-of-delivery-request creation trigger module 102 (steps in 206). It then either creates an email formatted for proof-of-delivery for sending to the recipient (steps in 207) or provides the necessary parts for the proof-of-delivery-request creation trigger module 102 to create the email formatted for proof-of-delivery (steps in 208). FIG. 24 illustrates the operation of the proof-of-delivery-request processing trigger module 108 (steps in 209) and FIG. 25 illustrates the operation of the proof-of-delivery-request processing module 109 (steps in 210).

### Fourth Set of Embodiments

FIGS. 11 to 20 illustrate the present disclosure as embodied by the line of products and services marketed by Kryptiva Inc. For the purposes of the present disclosure, Kryptiva Inc. can be typically considered as a TTP with regards to those using its services and components. As such, access to any of the Kryptiva™ components typically involves entering in an agreement with Kryptiva Inc. or obtaining software from it, such as through its website (http://www.kryptiva.com). As illustrated in FIG. 13, the above-described elements can be viewed as built into the Kryptiva™ components in the following fashion:
the proof-of-delivery-request creation trigger module 102, proof-of-delivery-request processing trigger module 108, proof-of-delivery-receipt acknowledgment module 118 and email recanting module 119 being integrated in the Kryptiva Mail Operator (KMO) 123,
the proof-of-delivery-request transmission module 114 and proof-of-delivery-request reception module 115 being integrated in the Kryptiva Packaging Plugin (KPP) 122,
the proof-of-delivery-request creation module 104 being integrated in the Kryptiva Packaging Server 124, and
the proof-of-delivery-request processing module 109 being integrated in the Online Unpacking Server 134 (OUS), which itself is part of the Kryptiva Online Services (KOS) 125.

FIG. 12 illustrates the integration of these components as part of a typical computer network. The Kryptiva Packaging Plugin 122 and Kryptiva Mail Operator 123 are typically freely available from the Kryptiva Inc. website, the Kryptiva Packaging Server 124 is typically available for organizations on a subscription basis from Kryptiva Inc., and the Kryptiva Online Services 125 is made accessible through the Internet.

As can be seen in FIG. 13, the sender station 103 and recipient station 106 operation of the present disclosure as implemented by the Kryptiva™ components is separated in two pieces, the Kryptiva Mail Operator 123 and the Kryptiva Packaging Plugin 122. There are many advantages to this configuration from a software development and maintenance perspective, but there is little difference from a functionality point of view should the client-side operation been implemented in a monolithic software component. Basically, the Kryptiva Packaging Plugin 122 is very specific to the email client application 121 (otherwise known as MUA or Mail-User Agent) and the Kryptiva Mail Operator 123 is a generic portable application. In other words, while there may be many Kryptiva Packaging Plugin 122 instances, one for each different email client application 121, there is meant to be only one Kryptiva Mail Operator 123 software package supporting all Kryptiva Packaging Plugin 122 instances. Support is implemented in the Kryptiva Packaging Plugin 122 and Kryptiva Mail Operator 123 for dealing with sender requests for including proof-of-delivery-requests in their email and recipient requests for processing proof-of-delivery-requests included in incoming email.

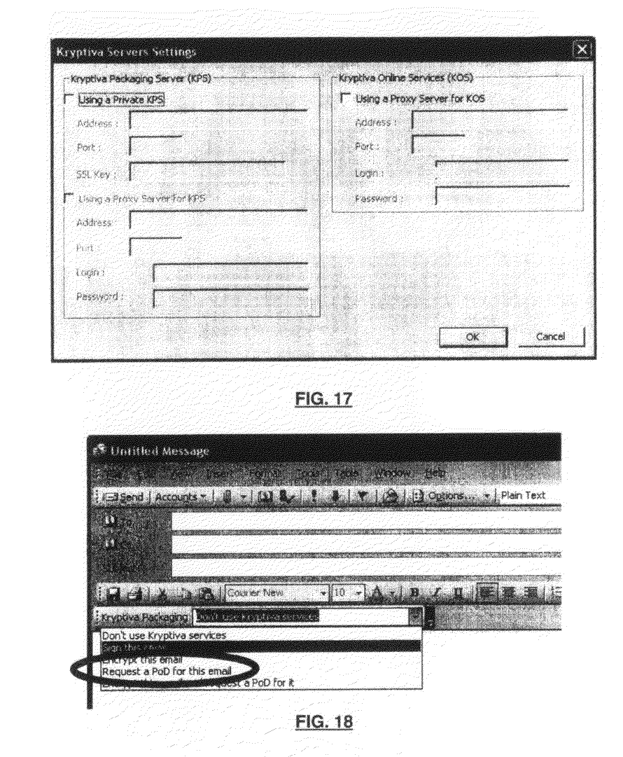

Typically, the Kryptiva Packaging Plugin 122 is implemented such that it hooks to the email client application's 121 “send” and “receive” functionality. The Kryptiva Packaging Plugin 122 for Microsoft® Outlook, for example, interfaces with Outlook using COM/ATL in order to be notified of specific user actions, such as when the “send” button is pressed or when new emails appear in folder or when an email is “opened” by way of double-clicking. The Kryptiva Packaging Plugins 122 for Mozilla Thunderbird™ and other email client applications 121 operate in a similar fashion to the Kryptiva Packaging Plugin 122 for Outlook. The Kryptiva Packaging Plugin 122 allows the user to configure the parameters for interacting with the Kryptiva Packaging Server 124 and the Kryptiva Online Services 125 as illustrated in FIGS. 16 and 17. At startup, the Kryptiva Packaging Plugin 122 launches a Kryptiva Mail Operator 123 instance, establishes a pipe or socket link to it in order to exchange data with it using the KMO-Plugin Pipe Protocol (K3P) 165 and provides it some of the basic information entered by the user in the Kryptiva Packaging Plugin 122 configuration menus for use by Kryptiva Mail Operator 123 in carrying out commands provided to it by the Kryptiva Packaging Plugin 122.

The Kryptiva Packaging Server 124 is implemented based on a customized Linux distribution and runs a daemon for dealing with requests for creating proof-of-delivery-requests. It contains two key pairs, the “encryption key pair” (EKP) and the “identity key pair” (IKP), as they are known in Kryptiva™ terminology. With regards to the IKP, both the public and the private key are available to the Kryptiva Packaging Server 124 and the Kryptiva Online Services 125. The IKP is typically used for implementing the system and method described in PCT International Publication Number WO 2005/078993. Since this key pair is already shared between the Kryptiva Online Services 125 and the Kryptiva Packaging Server 124 and in order to reduce complexity by avoiding further introducing an additional key pair, the IKP is reused in the context of the present disclosure for allowing users of the Kryptiva Packaging Server 124 to send emails formatted for proof-of-delivery. Of course, an additional separate key pair could also be used instead of reusing the existing IKP for other purposes. The IKP is based on 1024-bit RSA keys.

The Kryptiva Mail Operator 123 is implemented as a portable Unix® application linked with both the Libgcrypt and OpenSSL libraries. It is built natively on Unix® systems, such as Linux®, and is compiled using the MinGW environment in Windows®. The Kryptiva Mail Operator 123 is also linked with the SQLite library for storing information regarding emails it processes locally on the user station 138. Such information includes the symmetric key returned by the Kryptiva Packaging Server 124 at send time in order to allow a sender to read the emails formatted for proof-of-delivery that he himself sent, and the symmetric key returned by the Kryptiva Packaging Server 124 at reception time following a successful request for processing a proof-of-delivery-request.

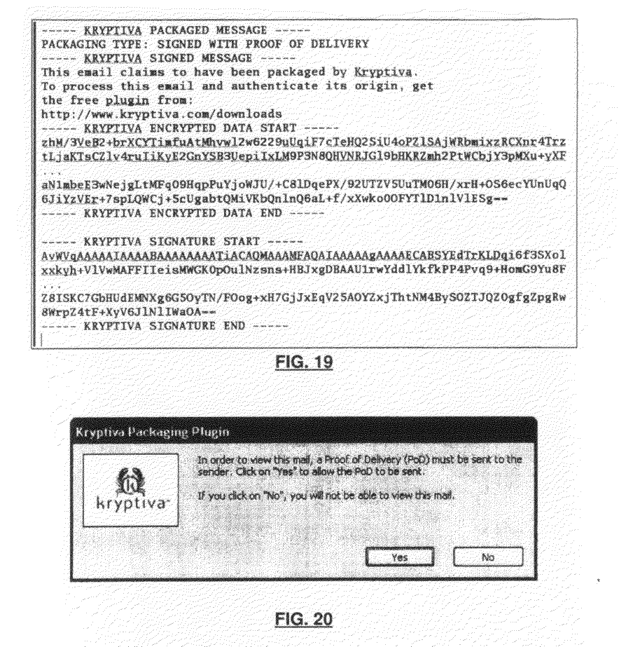

For offering the proof-of-delivery functionality to the user, the Kryptiva Packaging Plugin 122 displays an additional toolbar to the user's existing email composition window allowing the user to select a “Kryptiva Packaging” option, as illustrated in FIG. 18. The user can write his email as he would normally, and press “send” whenever ready.

Referring to FIG. 11, when the “send” button is pressed, the Kryptiva Packaging Plugin 122 intervenes and determines what needs to be done if a “Kryptiva Packaging” other than “Don't use Kryptiva services” is selected. If the user has selected a request for proof-of-delivery, the Kryptiva Packaging Plugin 122 proceeds to extract information regarding the outgoing email, such as the To, CC, Subject, Body, and attachments, using the interfaces provided by the Outlook API to plugins. Once retrieved, the information is provided to the Kryptiva Mail Operator 123 (arrow 165) along with instructions for creating an email formatted for proof-of-delivery. The Kryptiva Mail Operator 123 then, in turn, contacts the Kryptiva Packaging Server 124 using SSL, logs in using the information entered by the user in the Kryptiva Packaging Plugin 122 configuration menus, which was provided to the Kryptiva Mail Operator 123 at startup by the Kryptiva Packaging Plugin 122, and forwards the Kryptiva Packaging Plugin's 122 request to the Kryptiva Packaging Server 124 using the Kryptiva Network Protocol (KNP) 166. Having accepted the Kryptiva Mail Operator's 123 connection and authenticated the sender, the Kryptiva Packaging Server 124 then proceeds to first check whether the email appears to be spam or appears to contain a virus. If so, then the Kryptiva Packaging Server 124 refuses to create a proof-of-delivery-request and will inform the Kryptiva Mail Operator 123 of this which, in turn, will notify the Kryptiva Packaging Plugin 122 and the latter will display a pop-up to the user indicating that a problem has occurred. If there is no problem with the email, the Kryptiva Packaging Server 124 proceeds to create an email formatted for proof-of-delivery using the original email provided by the Kryptiva Mail Operator 123.

To that end, the Kryptiva Packaging Server 124 relies on Libgcrypt, an open-source cryptographic library, to conduct the cryptographic operations required for creating an email formatted for proof-of-delivery. First, the Kryptiva Packaging Server 124 generates a 128-bit AES symmetric key using Linux's pseudo-random number generator (/dev/urandom) and uses said symmetric key to encrypt the email body, thereby generating an encrypted email. Then it creates a proof-of-delivery-request by encrypting the symmetric key using the Kryptiva Packaging Servers 124 IKP public key, and aggregating it with other information, including the desired address at which the sender would like to receive a proof-of-delivery-receipt by email. It then includes the proof-of-delivery-request along with other data, such as a Member ID (MID) for identifying the private key the Kryptiva Online Services 125 will need to decrypt the encrypted symmetric key, into yet another aggregate, signs the latter and thereby generates a Kryptiva Signature Packet (KSP). The encrypted email and the KSP are combined to form an email formatted for proof-of-delivery which is returned back to the Kryptiva Mail Operator 123. The Kryptiva Packaging Server 124 also returns the unencrypted symmetric key to the Kryptiva Mail Operator 123 so that the sender may be able to read the emails formatted for proof-of-delivery that he himself sent.

It is worth noting that the Kryptiva Packaging Server 124 could be configured for adding to the proof-of-delivery-request other email addresses in addition to that specified by the sender for receiving his proof-of-delivery-receipt, say by adding a global email address specific to the organization operating the Kryptiva Packaging Server 124 in order to obtain a copy of proof-of-delivery-receipts for storage in a database for compliance purposes. The Kryptiva Packaging Server 124 may also be configured for substituting the address provided by the sender with another one altogether.

Other algorithms and key sizes than the ones previously mentioned could of course be used without departing from the teaching of the present disclosure. For example, elliptic curve cryptography or ElGamal could possibly be used. Similarly, other methods for generating symmetric keys could be used. For example, the Kryptiva Packaging Server 124 could use the Quantis product from idQuantique which relies on quantum effects for generating pure random numbers.

The Kryptiva Mail Operator 123 then stores the unencrypted symmetric key in the SOLite database and returns the email formatted for proof-of-delivery to the Kryptiva Packaging Plugin 122 which, in turn, substitutes the outgoing email with the email formatted for proof-of-delivery and lets Outlook transmit it as it would have transmitted the original email if the Kryptiva Packaging Plugin 122 were not present. FIG. 19 illustrates an email formatted for proof-of-delivery as generated by the Kryptiva Packaging Server 124.

At reception, or when the user opens an email, depending on the configuration, the Kryptiva Packaging Plugin 122, if it is installed, detects email formatted for proof-of-delivery and sends it to the Kryptiva Mail Operator 123 for preprocessing. First, Kryptiva Mail Operator 123 does a number of verifications on the email it receives from the Kryptiva Packaging Plugin 122, including checking the signature of the KSP and the email's integrity. It also checks for the email's packaging and reports all the information it finds back to the Kryptiva Packaging Plugin 122. If the email is marked as requiring a proof-of-delivery, the Kryptiva Packaging Plugin 122 will prompt the user for his agreement in sending the proof-of-delivery as illustrated in FIG. 20. If the user doesn't agree, then the email cannot be decrypted and it is left to the user in its encrypted form.

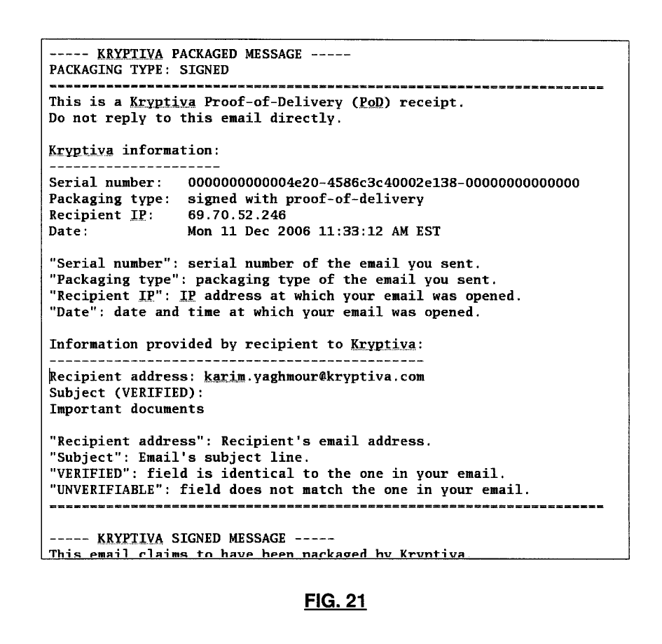

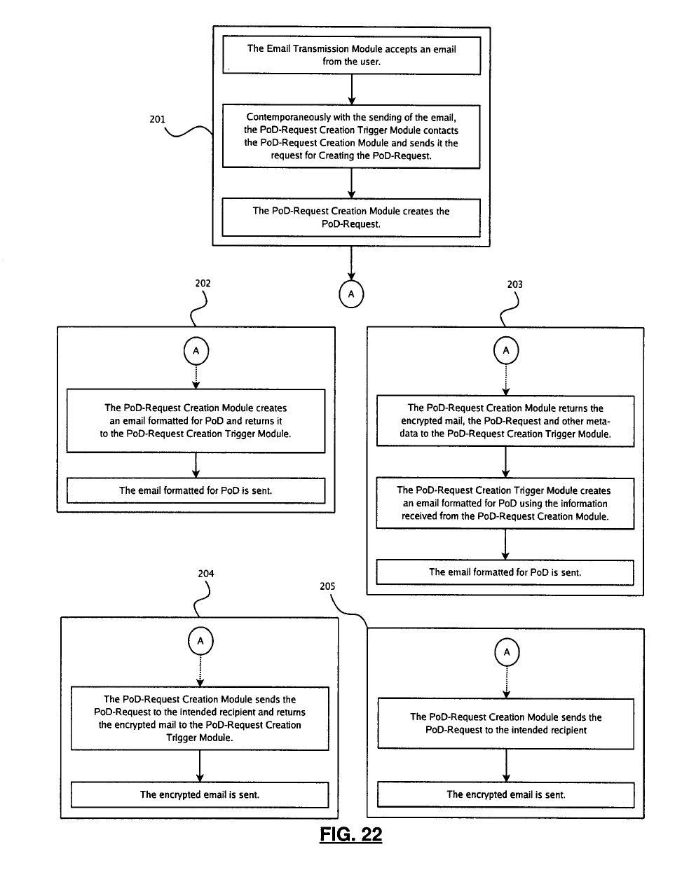

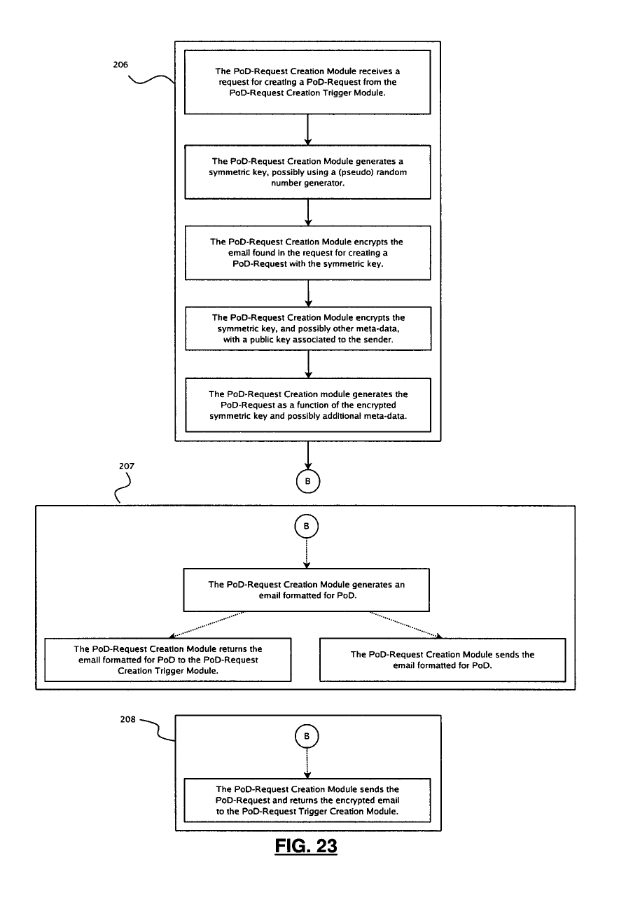

If the user accepts to process the proof-of-delivery, the Kryptiva Packaging Plugin 122 provides the email back again to the Kryptiva Mail Operator 123 and requests it to be processed for proof-of-delivery. The Kryptiva Mail Operator 123 then contacts the Online Unpacking Server 134 of the Kryptiva Online Services 125 (arrow 178), and provides it with the KSP, the recipient's email address, as claimed by the recipient, and a request for processing the proof-of-delivery request. The Online Unpacking Server 134 first verifies the integrity of the KSP, then retrieves the encrypted symmetric key and the MID from the KSP, retrieves the IKP private key matching the MID from an IKP private key database, decrypts the encrypted symmetric key with the private key, queues an email to be sent to the email address 159 found in the KSP as the address designated by the sender to receive his proof-of-delivery, and provides the recipient's Kryptiva Mail Operator 123 with the decrypted symmetric key. The Kryptiva Mail Operator 123 then stores this key in association with a unique identifier for the email to which it is designated into a local database for future use, decrypts the email using Libgrycpt and returns the decrypted email to the Kryptiva Packaging Plugin 122. The Kryptiva Packaging Plugin 122 then displays the email for the user using the API provided to plugins by the email client application. The sender eventually receives an email from the Kryptiva Online Services 125 indicating that the recipient has indeed read the email 164. An example of this is illustrated in FIG. 21.

FIG. 14 illustrates the implementation of the proof-of-delivery-receipt acknowledgment mechanism as implemented by the Kryptiva™ components. In essence, the proof-of-delivery-receipt sent by the Kryptiva Online Services 125 to the sender is packaged in a way that it will itself require processing for proof-of-delivery once received by the sender. And in that case, Kryptiva Mail Operator 123 automatically contacts the Kryptiva Online Services 125 when being provided such a proof-of-delivery-receipt for processing by the Kryptiva Packaging Plugin 122 in order to notify the Kryptiva Online Services 125 that the sender has received his proof-of-delivery-receipt 175.

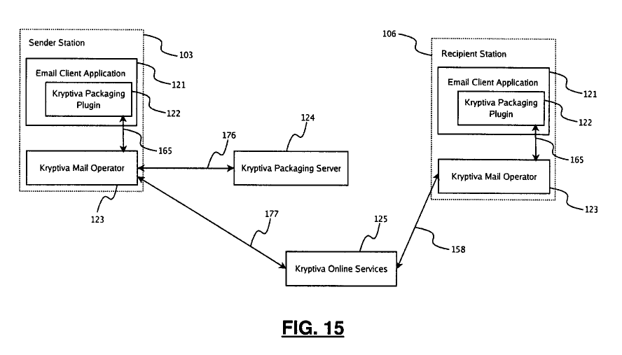

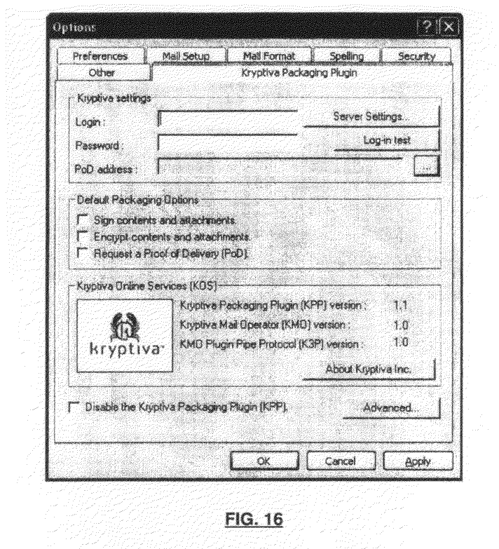

FIG. 15 illustrates the implementation of the email recanting functionality by the Kryptiva™ components. In this case, the Kryptiva Packaging Plugin 122 includes functionality for allowing the user to “recant” emails by clicking on a contextual menu or button. Once activated, the Kryptiva Packaging Plugin 122 retrieves information regarding the email to be recanted and provides it to the Kryptiva Mail Operator 123 with instructions to recant the email. Kryptiva Mail Operator 123 then contacts the Kryptiva Packaging Server 124 (arrow 176) to get an email recanting ticket which is then used with the Kryptiva Online Services 125 (arrow 177) to block recipients of the sender's email from being able to view its content. If the operation fails, the Kryptiva Mail Operator 123 informs the Kryptiva Packaging Plugin 122 which displays the appropriate pop-up to the user. The detailed operation of the proof-of-delivery-receipt acknowledgment and recanting functionality is as described earlier.

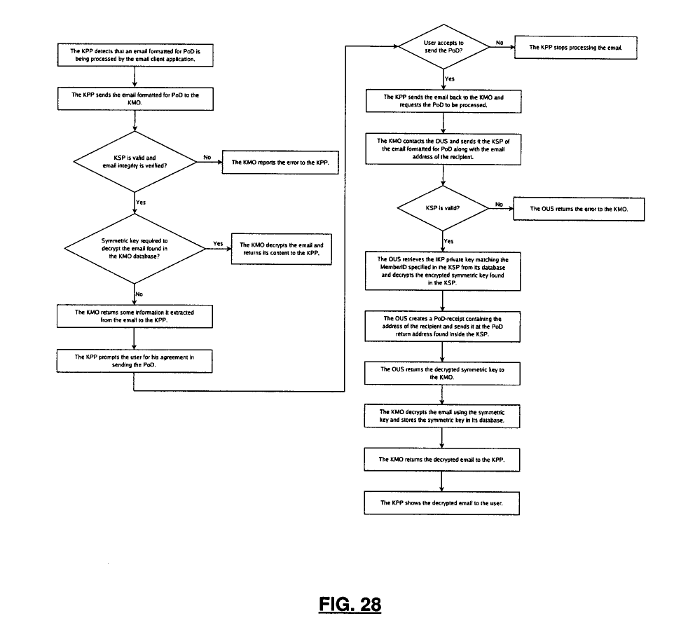

FIGS. 26 to 28 summarize the email proof-of-delivery method of the present disclosure as implemented by the Kryptiva™ components. FIGS. 26 and 27 illustrate the creation and sending of an email formatted for proof-of-delivery while FIG. 28 illustrates the reception and processing of an email formatted for proof-of-delivery.

While this disclosure uses a combination of private and public keys and a symmetric key to obtain an email proof-of-delivery system and method, other combinations of cryptographic algorithms could be used to achieve the same functionality. Namely that the proof-of-delivery-request may be packaged remotely from a sender's station yet locally on a sender's network, preferably, but not necessarily, without requiring the sender to contact a server outside the firewall, while still requiring the recipient to contact some public server in order to read an email he's received, thereby triggering a proof-of-delivery. Also, it is worth noting that while the present disclosure uses the term “email”, it will be evident to those skilled in the art that the present disclosure may be applicable to other forms of communication which resemble email such as, for example, instant messaging and GSM SMS messages.

It will be understood that numerous modifications and changes in form and detail may be made to the embodiments of the presently disclosed system and method for providing certified proof-of-delivery-receipts for electronic mail. It is contemplated that numerous other configurations of the system and method may be used, and the modules of the system and method may be selected from numerous modules other than those specifically disclosed. Therefore, the above description should not be construed as limiting the disclosed system and method, but merely as exemplification of the various embodiments thereof. Those skilled in the art will envisioned numerous modifications within the scope of the present disclosure as defined by the claims appended hereto. In short, it is the intent of the Applicant that the scope of the patent issuing herefrom will be limited only by the scope of the appended claims. Having thus complied with the details and particularity required by the patent laws, what is claimed and desired protected is set forth in the appended claims.

What is claimed is:

1. A system for generating a proof-of-delivery for an email, the system comprising:
an email transmission module configured for sending an email;
a proof-of-delivery-request creation module operating remotely from the email transmission module, the proof-of-delivery-request creation module being configured for producing a proof-of-delivery-request in response to a request for creating the proof-of-delivery-request;
a proof-of-delivery-request creation trigger module connectable to the proof-of-delivery-request creation module, the proof-of-delivery-request creation trigger module being configured for generating the request for creating the proof-of-delivery-request contemporaneously with the sending of the email;
a proof-of-delivery-request processing module configured for generating a proof-of-delivery for the email in response to a request for processing the proof-of-delivery-request;
an email reception module configured for receiving the email; and
a proof-of-delivery-request processing trigger module connectable to the proof-of-delivery-request processing module, the proof-of-delivery-request processing trigger module being configured for triggering the request for processing the proof-of-delivery-request contemporaneously with the reception of the proof-of-delivery-request, whereby the generation of the proof-of-delivery by the proof-of-delivery-request processing module is a necessary condition for a recipient to read the email received by the email reception module.

2. A system of claim 1, further comprising:
a proof-of-delivery-request transmission module configured for causing the sending of the proof-of-delivery-request; and
a proof-of-delivery-request reception module configured for receiving the proof-of-delivery-request.

3. A system according to claim 1, wherein the proof-of-delivery-request processing module accepts anonymous requests for processing proof-of-delivery requests.

4. A system according to claim 1, wherein the proof-of-delivery-request creation module is separate from the proof-of-delivery-request processing module.

5. A system according to claim 1, further comprising a random key generation module connectable to the proof-of-delivery-request creation module, the random key generation module being configured for generating a symmetric key.

6. A system according to claim 5, further comprising a symmetric key encryption module connectable to the proof-of-delivery-request creation module, the symmetric key encryption module being configured for producing an encrypted symmetric key as a function of a public key and the symmetric key, wherein the encrypted symmetric key is made to be a component of the proof-of-delivery-request.

7. A system according to claim 6, further comprising an email encryption module connectable to the proof-of-delivery-request creation module, the email encryption module being configured for producing an encrypted email as a function of the symmetric key.

8. A system according to claim 7, further comprising a proof-of-delivery-request formatting module configured for producing an email formatted for proof-of-delivery by combining the encrypted email with the proof-of-delivery-request.

9. A system according to claim 8, wherein the proof-of-delivery-request formatting module is connectable to proof-of-delivery-request creation module.

10. A system according to claim 8, wherein the proof-of-delivery-request formatting module is connectable to the proof-of-delivery-request creation trigger module.

11. A system according to claim 8, further comprising a proof-of-delivery-request transmission module configured for substituting the email with the email formatted for proof-of-delivery, wherein said substitution is effected contemporaneously with the transmission of the email by the email transmission module.

12. A system according to claim 11, wherein the proof-of-delivery-request transmission module is connectable to the proof-of-delivery-request creation trigger module.

13. A system according to claim 11, wherein the proof-of-delivery-request transmission module is connectable to the proof-of-delivery-request creation module.

14. A system according to claim 11, wherein the email received by the email reception module is the email formatted for proof-of-delivery.

15. A system according to claim 14, further comprising a proof-of-delivery-request processing module configured for receiving the proof-of-delivery-request part of the email formatted for proof-of-delivery.

16. A system according to claim 15, wherein the proof-of-delivery-request processing module is further configured for decrypting the symmetric key found in the proof-of-delivery-request using a private key.

17. A system according to claim 16, wherein the proof-of-delivery-request processing module is further configured to return the decrypted symmetric key to the proof-of-delivery-request processing trigger module.

18. A system according to claim 17, wherein the proof-of-delivery-request processing trigger module is further configured for decrypting the encrypted email found as part of the email formatted for proof-of-delivery using the decrypted symmetric key.

19. A system according to claim 1, wherein the email transmission module is a sender's email client application.

20. A system according to claim 19, wherein the proof-of-delivery-request creation trigger module is connected to the sender's email client application by way of a plugin.

21. A system according to claim 20, wherein the email reception module is a recipient's email client application.

22. A system according to claim 21, wherein the proof-of-delivery-request processing trigger module is connectable to the recipient's email client application by way of a plugin.

23. A system according to claim 22, wherein the proof-of-delivery-request creation module is integrated in a proof-of-delivery-request creation server.

24. A system according to claim 23, wherein the proof-of-delivery-request processing module is integrated in a proof-of-delivery-request processing server.

25. A system according to claim 24, wherein the email transmission module and the proof-of-delivery-request creation trigger module are integrated in a sender unit.

26. A system according to claim 25, wherein the email reception module and the proof-of-delivery-request processing trigger module are integrated in a recipient unit.

27. A system according to claim 26, wherein the sender unit is a sender station.

28. A system according to claim 27, wherein the recipient unit is a recipient station.

29. A system for obtaining a proof-of-delivery for a message, the system comprising:
a message transmission module configured for sending a message;
a proof-of-delivery-request creation module operating remotely from the message transmission module, the proof-of-delivery request creation module being configured for producing a proof-of-delivery-request in response to a request for creating the proof-of-delivery-request, wherein:
the request for creating a proof-of-delivery-request includes the message and meta-data about the message,
the message is encrypted using a symmetric key, thereby producing an encrypted message, and
the proof-of-delivery-request is produced as a function of the symmetric key, the meta-data about the message and a public key;
a proof-of-delivery-request creation trigger module connectable to the proof-of-delivery-request creation module, the proof-of-delivery-request creation trigger module being configured for producing the request for creating the proof-of-delivery-request and substituting the message with a message formatted for proof-of-delivery contemporaneously with the sending of the message, wherein the message formatted for proof-of-delivery is produced by combining the encrypted message with the proof-of-delivery-request;
a proof-of-delivery-request processing module configured for receiving a request for processing a proof-of-delivery-request, retrieving the symmetric key from the proof-of-delivery-request using a private key matching the public key and generating a proof-of-delivery for the message, wherein the request for processing the proof-of-delivery-request includes the proof-of-delivery-request and meta-data about the message;
a message reception module configured for receiving the message formatted for proof-of-delivery; and
a proof-of-delivery-request processing trigger module connectable to the proof-of-delivery-request processing module, the proof-of-delivery-request processing trigger module being configured for triggering the request for processing the proof-of-delivery-request contemporaneously with the reception of the message formatted for proof-of-delivery, receiving the symmetric key from the proof-of-delivery request-processing module and decrypting the encrypted message using said symmetric key.

30. A system according to claim 29, wherein the message is an email.

31. A system according to claim 30, wherein the email meta-data includes the sender's email address.

32. A system according to claim 29, wherein the symmetric key is randomly generated by the proof-of-delivery-request creation module.

33. A system according to claim 29, wherein the message is an email.

34. A method for generating a proof-of-delivery for an email, the method comprising:
a) generating a request for producing a proof-of-delivery-request contemporaneously with the sending of an email, wherein the email is sent by an email transmission module;
b) producing a proof-of-delivery-request remotely from the email transmission module in response to the request for producing a proof-of-delivery-request;
c) generating a request for processing the proof-of-delivery-request contemporaneously with the reception of the proof-of-delivery-request; and
d) generating a proof-of-delivery remotely from an email reception module in response to a request for processing a proof-of-delivery-request, wherein the generation of the proof-of-delivery is a necessary condition for a recipient to read the email received by the email reception module.

35. A method for generating a proof-of-delivery for an email, the method comprising:
a) generating a request for producing a proof-of-delivery-request contemporaneously with the sending of an email, wherein the email is sent by an email transmission module;
b) generating a symmetric key remotely from the email transmission module in response to the request for producing a proof-of-delivery-request;
c) encrypting the email using the symmetric key, thereby obtaining an encrypted email;
d) encrypting the symmetric key using a public key, thereby obtaining an encrypted symmetric key;
e) substituting the email with an email formatted for proof-of-delivery, wherein the email formatted for proof-of-delivery is produced as a function of the encrypted email and the encrypted symmetric key;
f) generating a request for processing the proof-of-delivery-request contemporaneously with the reception of the email formatted for proof-of-delivery by an email reception module;
g) generating a proof-of-delivery remotely from the email reception module in response to the request for processing the proof-of-delivery-request;
h) decrypting the encrypted symmetric key found in the email formatted for proof-of-delivery using a private key, thereby obtaining a decrypted symmetric key; and
i) decrypting the encrypted email found in the email formatted for proof-of-delivery using the decrypted symmetric key.
